SEQUENCE LISTING (10 sequences)

SEQ ID NO: 1 - protein, 35 aa, synthetic construct
GSSAAAAAAAASGPGGYGPENQGPSGPGGYGPGGP

SEQ ID NO: 2 - protein, 35 aa, synthetic construct
GSSAAAAAAAASGPGGYGPENQGPCGPGGYGPGGP

SEQ ID NO: 3 - protein, 35 aa, synthetic construct
GSSAAAAAAAASGPGGYGPKNQGPSGPGGYGPGGP

SEQ ID NO: 4 - protein, 11 aa, synthetic construct
MASMTGGQQMG

SEQ ID NO: 5 - protein, 4 aa, synthetic construct
RGSM

SEQ ID NO: 6 - protein, 576 aa, synthetic construct
MASMTGGQQMGRGSMGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPG

SEQ ID NO: 7 - protein, 576 aa, synthetic construct
MASMTGGQQMGRGSMGSSAAAAAAAASGPGGYGPKNQGPSGPGGYGPGGPGSSAAAAAAAASGPGGYGPKNQGPSGPGGYGPGGPGSSAAAAAAAASGPGGYGPKNQGPSGPGGYGPGGPGSSAAAAAAAASGPGGYGPKNQGPSGPGGYGPGGPGSSAAAAAAAASGPGGYGPKNQGPSGPGGYGPGGPGSSAAAAAAAASGPGGYGPKNQGPSGPGGYGPGGPGSSAAAAAAAASGPGGYGPKNQGPSGPGGYGPGGPGSSAAAAAAAASGPGGYGPKNQGPSGPGGYGPGGPGSSAAAAAAAASGPGGYGPKNQGPSGPGGYGPGGPGSSAAAAAAAASGPGGYGPKNQGPSGPGGYGPGGPGSSAAAAAAAASGPGGYGPKNQGPSGPGGYGPGGPGSSAAAAAAAASGPGGYGPKNQGPSGPGGYGPGGPGSSAAAAAAAASGPGGYGPKNQGPSGPGGYGPGGPGSSAAAAAAAASGPGGYGPKNQGPSGPGGYGPGGPGSSAAAAAAAASGPGGYGPKNQGPSGPGGYGPGGPGSSAAAAAAAASGPGGYGPKNQGPSGPGGYGPGGPG

SEQ ID NO: 8 - protein, 610 aa, synthetic construct
MASMTGGQQMGRGSMGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPCGPGGYGPGGP

SEQ ID NO: 9 - protein, 1136 aa, synthetic construct
MASMTGGQQMGRGSMGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPG

SEQ ID NO: 10 - protein, 1696 aa, synthetic construct
MASMTGGQQMGRGSMGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPG

(19) United States
(12) Patent Application Publication
(10) Pub. No.: US 2026/0242699 A1
(43) Pub. Date: Aug. 20, 2026

(54) LAUNDRY DETERGENT COMPOSITION COMPRISING A STRUCTURAL POLYPEPTIDE

(71) Applicant: AMSILK GMBH, Neuried (DE)

(72) Inventors: Andreas SCHMIDEDER, Velden (DE); Mauro DAVANZO, Ludwigshafen am Rhein (DE)

(21) Appl. No.: 19/152,857

(22) PCT Filed: Feb. 1, 2024
(86) PCT No.: PCT/EP2024/052455

§ 371 Date: Jul. 31, 2025

(30) Foreign Application Priority Data
Feb. 2, 2023 (EP) 23154766.2

(51) Int. Cl. C11D 3/38; C11D 3/00; C11D 17/00

(52) U.S. Cl. CPC C11D 3/38; C11D 3/0036; C11D 17/003

(57) ABSTRACT

The present invention relates to a laundry detergent composition comprising a structural polypeptide, a method for cleaning soiled fabric in a washing machine using said laundry detergent composition, the use of a structural polypeptide in a laundry detergent composition and the use of the laundry detergent composition for the treatment of soiled fabric.

### CROSS REFERENCE TO RELATED APPLICATIONS

This application is a U.S. National Stage of PCT/EP2024/052455, international filing date Feb. 1, 2024, which claims priority to European Application No. 23154766.2, filing date Feb. 2, 2023.

### REFERENCE TO SEQUENCE LISTING IN ELECTRONIC FORMAT

The contents of the electronic sequence listing (558-121-pct-sequence-listing.xml; Size: 14,362 bytes; and Date of Creation: Jan. 29, 2024) is herein incorporated by reference in its entirety.

The present invention relates to a laundry detergent composition comprising a structural polypeptide, a method for cleaning soiled fabric in a washing machine using said laundry detergent composition, the use of a structural polypeptide in a laundry detergent composition and the use of the laundry detergent composition for the treatment of soiled fabric.

### BACKGROUND OF THE INVENTION

The cleaning of textiles in washing machines and with the corresponding detergents has been known for over 100 years. Modern laundry detergents generally comprise a complex composition of functional components which usually comprises a blend of detergent-active compounds, selected from anionic, nonionic, amphoteric and cationic surfactants, along with a plethora of possible further ingredients such as builders, soil release and anti-redeposition additives, enzymes, bleaching agents and many more. Actual detergents have to meet a complex profile of requirements, where good washing performance is only one aspect among several. In order to be accepted by the customers, today's detergents must meet the requirements for sustainable, ecologically compatible products. This includes extending the life of the textiles as much as possible while maintaining their properties, such as wearing comfort, colours and fit, for as long as possible. For the preservation of the mechanical properties, it is important to protect the fibres of the fabrics from mechanical stress, both during washing and in use. This purpose is achieved by finishes/coatings that reduce the mechanical stress and consequently the natural abrasion and fibrillation degradation of the fibers. Customers prefer laundry detergent compositions that impart such positive properties to the fibers during the usual washing of the laundry over finishing additives that have to be separately added to the washing machine or even have to be applied to the textiles outside the washing machine. Such additives should be biodegradable and/or harmless to humans, animals and the environment. It is further a global goal to reduce microplastic emissions in all sectors. This includes reducing the amount of microfibres released during washing.

There is a need for additives that have a good effect, especially at very low application rates, and/or where the effect lasts even after one or more washes without the additive. Those additives should be compatible with the complex formulations of today's laundry detergent compositions and be suitable to be formulated in the different forms of laundry detergent compositions known in the art, such as liquid detergents, gels, tablets (tabs), capsules (caps), water soluble pouches (liquid tabs), water soluble containers, etc.

It is known that regenerated silk fibroin is suitable for the surface modification of textile material through deposition. H.-T. Ngo and T. Bechtold describe in J. Appl. Polym. Sci 2017, DOI: 10.1002/APP.45098 the preparation of fibroin coated fabric samples from man-made fibers, like viscose and polyamides, by deposition of a fibroin-calcium complex on the textiles from a CaCl₂)/water/ethanol medium in a complex process, wherein a destablization agent is added to the medium, the resulting mixture is padded on the fabric and dried afterwards. This article presents results of basic research and does not contain any reference to a process for coating textiles for everyday use in a practicable manner.

It has now been found that, surprisingly, structural polypeptides, such as silk polypeptides, are suitable for the formulation of laundry detergent compositions with improved application properties. Silk polypeptides are polymers that exhibit exceptional application properties and can impart laundry detergent formulations with a variety of benefits, including the ability of forming a homogeneous coating on a variety of fibers, a good fiber protection, improvement or maintenance of the mechanical properties and/or the usage properties of textiles, including the optics and haptic of textiles. Surprisingly, the structural polypeptides are deposited on the fibers of textiles even with very low application amounts at the harsh conditions in the washing cycle. It is also surprising that the structural polypeptide forms a homogenous coating on the fibers under those application conditions. It is surprising, too, that the structural polypeptide, in particular silk polypeptide, is compatible with the known actual laundry detergent products, without the occurrence of negative effects, like precipitation, etc. Structural polypeptides, such as silk polypeptides, are biocompatible, non-toxic and environmental friendly and suitable for the formulation of any form of laundry detergent compositions, such as liquids, gels and mono-dose forms.

### SUMMARY OF THE INVENTION

A first object of the invention is a laundry detergent composition, comprising:
a) a structural polypeptide, especially a silk polypeptide and
b) at least one surfactant.

A preferred embodiment is a laundry detergent composition, comprising:
a) at least one structural polypeptide,
b) at least one anionic surfactant b1), and optionally at least one nonionic surfactant b2),
c) optionally at least one builder,
d) optionally at least one enzyme,
e) optionally at least one polymeric antiredeposition agent,
f) optionally at least one bleach,
g) optionally at least one further additive different from components a) to f), preferably selected from surfactants different from anionic and nonionic surfactants, rheology modifier, pH modifying agents, corrosion inhibitors, defoamers, dyes, fragrances, fillers, tableting aids, disintegrants, solubilizers, electrolytes, optical brighteners, hydrotropes, antiredeposition agents, antimicrobial ingredients, antioxidants and mixtures thereof,
h) optionally at least one organic solvent,
i) optionally water.

In one preferred embodiment, the laundry detergent composition according to the invention is liquid. In another preferred embodiment, the laundry detergent composition according to the invention is a unit dose article.

A further object of the invention is a method for cleaning laundry in a washing machine, in which the laundry to be cleaned is contacted with a laundry detergent composition as defined above and in the following.

A further object of the invention is the use of a structural polypeptide, especially a silk polypeptide, as defined above and in the following, in a laundry detergent composition.

A further object of the invention is the use of a laundry detergent composition, as defined above and in the following, in the treatment of laundry in a washing machine for
improving or maintaining the properties of textiles, in particular improving or maintaining at least one property selected from
i) the mechanical properties and/or usage properties of textiles,
ii) the optics of textiles,
iii) the haptic of textiles and/or
iv) the odor properties of textiles,
extending the life of textiles,
reducing the amount of microfibres released during washing,
enabling to dispense the use of additional laundry care products.

This summary of the invention does not necessarily describe all features of the present invention. Other embodiments will become apparent from a review of the ensuing detailed description.

### DETAILED DESCRIPTION OF THE INVENTION

Before the present invention is described in detail below, it is to be understood that this invention is not limited to the particular methodology, protocols and reagents described herein as these may vary. It is also to be understood that the terminology used herein is for the purpose of describing particular embodiments only, and is not intended to limit the scope of the present invention which will be limited only by the appended claims. Unless defined otherwise, all technical and scientific terms used herein have the same meanings as commonly understood by one of ordinary skill in the art.

Preferably, the terms used herein are defined as described in “A multilingual glossary of biotechnological terms: (IUPAC Recommendations)”, Leuenberger, H. G. W, Nagel, B. and Kölbl, H. eds. (1995), Helvetica Chimica Acta, CH-4010 Basel, Switzerland).

Several documents are cited throughout the text of this specification. Each of the documents cited herein (including all patents, patent applications, scientific publications, manufacturer's specifications, instructions, GenBank Accession Number sequence submissions etc.), whether supra or infra, is hereby incorporated by reference in its entirety. Nothing herein is to be construed as an admission that the invention is not entitled to antedate such disclosure by virtue of prior invention.

In the following, the elements of the present invention will be described. These elements are listed with specific embodiments. However, it should be understood that they may be combined in any manner and in any number to create additional embodiments. The variously described examples and preferred embodiments should not be construed to limit the present invention to only the explicitly described embodiments. This description should be understood to support and encompass embodiments which combine the explicitly described embodiments with any number of the disclosed and/or preferred elements.

Furthermore, any permutations and combinations of all described elements in this application should be considered disclosed by the description of the present application unless the context indicates otherwise.

Structural polypeptides, such as silk polypeptides, are particularly advantageous for use in laundry detergent compositions which must meet a complex property profile. The laundry detergent composition of the invention has at least one, preferably two, three or more of the following advantages:
Structural polypeptides, in particular silk polypeptides, are polymers that exhibit exceptional application properties and can impart laundry detergent formulations with a variety of benefits.
The composition shows effective action even with very low application quantities and under the harsh conditions in the wash cycles. The structural polypeptide is capable of forming a homogenous coating on the fibres under those application conditions.
The composition of the invention is capable of improving or maintaining the properties of textiles, in particular improving or maintaining the mechanical properties and/or usage properties of textiles, the optics of textiles, the haptic of textiles and/or the odour properties of textiles.
The composition shows good cleaning of the laundry, is suitable for improving the soil removability and/or preventing resoiling of the laundry.
The composition of the invention is suitable to impart the textiles with a fiber protection against mechanical stress during wash and wear. The natural abrasion and fibrillation degradation of the fibers is improved.
The composition is suitable for extending the life of textiles.
The composition is further suitable for reducing the amount of microfibres released during washing.
The use of a structural polypeptide, in particular a silk polypeptide, in the laundry detergent compositions allows to dispense the use of additional laundry care products. The effect lasts even after one or more washes without the additive.
The structural polypeptide, in particular silk polypeptide, is compatible with the known actual laundry detergent products, without the occurrence of negative effects, like precipitation, etc.
The structural polypeptides, in particular the silk polypeptides, are suitable for the use in a great variety of different laundry detergent formulations, including liquid detergents, gels, tablets (tabs), capsules (caps), water soluble pouches (liquid tabs), water soluble containers, etc. They are suitable for mono-compartment and multi-compartment products comprising liquid and solid components or fully liquid products. The formulations allow an effective prevention of a deterioration or precipitation of the structural polypeptide, in particular silk polypeptide, and a controlled release with an effective amount in the liquid medium of the rinse cycle.
The structural polypeptides, in particular the silk polypeptides, contained in the laundry detergent compositions according to the invention are biocompatble, non-toxic, not environmentally harmful and safe for humans and animals. Especially the silk proteins are made exclusively from renewable sources, are 100% biodegradable and free of microplastic. In regulatory and environmental issues this can be advantageous over compositions based on conventional ingredients.
The structural polypeptides, in particular the silk polypeptides, are suitable for the use in phosphate free formulation.

Without wishing to be bound by any theory, it is believed that the employed structural polypeptides, in particular silk polypeptides, are suitable to form a coating on textile fibers that imparts the textiles with improved properties. The structural polypeptide adheres to the surfaces and thus leads to an improvement of the mechanical properties, like the tensile strength. The coating on the textile fibers acts like a friction inhibitor and reduces the abrasion of the fibers during the wash cycles. It can be assumed that the coating is also responsible for the observed fiber protection when using the textiles.

The laundry detergent composition of the invention may be in any form, preferably liquids, gels, tablets (tabs), capsules (caps), water soluble pouches (liquid tabs), water soluble containers, etc. Water-soluble film-forming polymers, in particular with special release characteristics, can be used as a sheath or as a coating for the complete laundry detergent compositions or at least one of the components thereof. Capsules or containers may have a single compartment or may be a multi-compartment system.

In a preferred embodiment, the laundry detergent composition according to the invention is liquid. Liquid laundry detergent compositions contain as solvent generally water or a mixture of water and at least one organic solvent that is at least partly water miscible. Liquid laundry detergent compositions usually contain builders, but nonbuilt formulations are also known. The last-mentioned contain in a special embodiment nonionic surfactants in an amount of up to 40 weight % or more. Further typical components of liquid laundry detergent compositions, that in some embodiments are present, in other embodiments not, are hydrotropes and/or antiredeposition polymers. The liquid laundry detergent compositions are suitable to be formulated as concentrates, having a reduced water-content in comparison to normal products.

In a further preferred embodiment, the laundry detergent composition according to the invention is in the form of a unit dose article. Unit dose articles are intended for single-serve applications and products. In the domestic sector so called “mono dose” products are popular that contain the correct amount of a laundry detergent formulation sufficient for a single washing operation. In the context of this application, the terms “unit dose”, “mono dose” and “single pack” are used synonymously.

The unit dose laundry detergent composition of the invention can be in the form of a mono-compartment or multi-compartment (multi-chamber) formulation. The laundry detergent composition is suitable for all common types of unit dose articles, marketed as tablets (tabs), water soluble pouches (also denoted as capsules, caps, liquid tabs, liquitabs, pods or packs), water soluble containers, etc. Water-soluble film-forming polymers can be used as a sheath or as a coating for the complete laundry detergent composition or at least one of the components thereof. Suitable water-soluble polymers are known by a person skilled in the art and are e.g. selected from polyvinylalcohol, milk proteins, polyvinyl pyrrolidone, polyalkylene oxides, blends and copolymers of polyalkylene oxides and acrylic acid (esters), cellulose, cellulose ether, cellulose ester, etc. One example of typical water-soluble polymers are polyvinylalcohol (PVOH) homopolymers or copolymers. Special release characteristics, e.g. the dissolution time in water at a certain temperature, can be obtained by the use of certain comonomers (like vinyl esters, e.g. vinyl acetate, alkyl acrylates, e.g. methyl or ethyl (meth)acrylate) and their amounts.

In a special embodiment, the laundry detergent composition is comprised in a water-soluble multi-chamber unit dose. The unit dose can be in the form of films or shaped bodies, having 1, 2, 3, 4, 5, 6 or more than 6 individual sections. Suitable are unit doses coated with or wrapped in a water-soluble polymer film or contained in containers prepared from water soluble polymers. Each compartment (section) of a multicompartment formulation may be independently filled with liquids, powders, granules, gels, pastes, etc. or a combination thereof. Thus, it is possible to use components with stability problems, e.g. because they are hygroscopic or incompatible with other ingredients, even in complex laundry detergent compositions. Accordingly, the laundry detergent compositions according to the invention may comprise a mixture of two or more forms, e.g. a gel component and a powder component. In a possible embodiment, the structural polypeptide a) can be dispensed in a separate compartment of a multi-compartment formulation.

The laundry detergent compositions according to the invention in form of a unit dose article may be completely liquid (i.e. consist of one or more liquid components) or they may contain liquid and solid components or they may be completely solid (i.e. consist of one or more solid components).

The unit dose articles contain no added water or only a limited amount of water to ensure that the water-soluble polymer remains stable before the pack is used for washing. In one embodiment, the laundry detergent compositions according to the invention in form of a unit dose article contains water in an amount of at the most 10% by weight, more preferably 5% by weight, in particular 1% by weight, especially 0.5% by weight, based on the total weight of the composition. In a special embodiment, the laundry detergent compositions contain no added water at all.

Laundry detergent compositions according to the invention in form of a unit dose article that are fully liquid or contain at least one liquid component in general contain at least one organic solvent instead of or in addition to water. Preferred solvents are fully water-miscible or at least partly water-miscible organic solvents.

In a typical embodiment, laundry detergent compositions in form of a unit dose article contain at least one builder. Only in solid formulations non soluble components, e.g. non soluble builders (like zeolites), fillers, etc. may be contained.

In a special embodiment, the laundry detergent composition contains the structural polypeptide a) in form of a hydrogel.

The laundry detergent composition of the invention is preferably phosphate-free. By “phosphate-free” it is herein understood that the composition comprises less than 1% by weight, preferably less than 0.10%, in particular less than 0.05% by weight, based on the total weight of the composition of phosphate. “Phosphate-free” means that the laundry detergent composition is free of alkali metal orthophosphates and polyphosphates, in particular pentasodium triphosphate (sodium tripolyphosphate, STPP).

Component a) (Structural Polypeptide) In the context of the present invention, the terms “polypeptide” and “protein” are used interchangeably. They refer to a long chain of amino acids with peptide linkage, e.g. one that is at least 30 amino acids long.

The term “structural polypeptide”, as used herein, refers to any polypeptide which comprises repeat units (repeating building blocks) made of amino acids. The structural polypeptide preferably has the ability to perform polypeptide assembly. In particular, the structural polypeptide is capable of forming protein complexes (aggregates) in formulations, e.g. hydrogels in aqueous formulations. The structural polypeptide may be selected from the group consisting of silk polypeptide (including fibroin), keratin, collagen, and elastin or variants or combinations thereof. The structural polypeptide is particularly a recombinant or synthetic structural polypeptide. The structural polypeptide is preferably a (recombinant or synthetic) silk polypeptide, such as a (recombinant or synthetic) spider silk polypeptide. An exemplarily process for producing a silk polypeptide is described in WO 2006/008163 and in WO 2011/120690.

The term “silk polypeptide”, as used herein, refers to a polypeptide which shows, in comparison to other polypeptides, a quite aberrant amino acid composition. In particular, a silk polypeptide possesses large quantities of hydrophobic amino acids such as glycine or alanine. In addition, a silk polypeptide contains highly repetitive amino acid sequences or repetitive units (repeat units, modules), especially in their large core domain. Based on DNA analysis, it was shown that all silk polypeptide are chains of repetitive units which further comprise a limited set of distinct shorter peptide motifs. The expressions “peptide motif” and “consensus sequence” can be used interchangeably herein. Generally, the silk consensus sequences can be grouped into four major categories: GPGXX, GGX, Ax or (GA)n and spacers. These categories of peptide motifs in silk polypeptides have been assigned structural roles. For example, it has been suggested that the GPGXX motif is involved in a β-turn spiral, probably providing elasticity. The GGX motif is known to be responsible for a glycine-rich 3₁-helix. Both GPGXX and GGX motifs are thought to be involved in the formation of an amorphous matrix that connects crystalline regions, thereby providing elasticity of the fiber. Alanine-rich motifs typically contain 6-9 residues and have been found to form crystalline β-sheets. The spacers typically contain charged groups and separate the iterated peptide motifs into clusters. The silk polypeptide can perform polypeptide assembly.

Fibroin is a structural polypeptide and a silk polypeptide in the sense of the invention.

The silk polypeptide is particularly a recombinant or synthetic silk polypeptide.

Preferably, the (recombinant or synthetic) silk polypeptide is a (recombinant or synthetic) spider silk polypeptide.

The term “polypeptide-assembly”, as used herein, refers to a process in which a disordered system of pre-existing polypeptides forms an organized structure or pattern as a consequence of specific, local interactions (e.g. van der Waals forces, hydrophobic interactions, hydrogen bonds, and/or salt-bridges, etc.) among the polypeptides themselves, without external direction or trigger although external factors might influence speed and nature of polypeptide-assembly. This particularly means that when two or more disordered and/or unfolded polypeptides are brought into contact, they interact with each other and consequently form a three-dimensional structure. The change from a disordered system to an organized structure or pattern during self-polypeptide assembly is characterized by a transition from a fluid state to a gel-like and/or solid state and a corresponding increase in viscosity. The transition from a fluid state to a gel-like state can be monitored, for example, by optical measurement or rheology measurement. These techniques are known to the skilled person. The transition from a fluid state to a solid state can be monitored, for example, using optical methods.

Preferably, the structural polypeptide conducting polypeptide assembly is a (recombinant or synthetic) silk polypeptide, such as a (recombinant or/synthetic) spider silk polypeptide.

The term “polypeptide aggregates” (or polypeptide complexes), as used herein, refers to polypeptide structures which are formed as a result of polypeptide self-assembly. In the process of polypeptide self-assembly, multiple copies/units of polypeptides self-aggregate into a body or mass without external direction or trigger although external factors might influence speed and nature of self-polypeptide assembly. In the polypeptide aggregates, the different polypeptides are connected with or attached to each other via covalent (e.g. disulfide bridges) and/or non-covalent interactions (e.g. van der Waals forces, hydrophobic interactions, hydrogen bonds, and/or salt-bridges). It should be clear that a polypeptide aggregate encompasses at least two polypeptides. In the context of the present invention, the self-assembly of (recombinant or/synthetic) silk polypeptides is described. During the process of silk polypeptide self-assembly, silk polypeptide aggregates (silk polypeptide complexes) are formed.

The term “hydrogel”, as used herein, refers to a structure that is formed if the concentration of structural polypeptides is high enough to build a continuous network by which the liquid component is immobilized. Said network is preferably formed by polypeptide assembly of the structural polypeptides providing the basis of the hydrogel. In particular, the hydrogel is a hydrophilic polymeric network of structural polypeptides. Said network is stabilized by chemical and/or physical interactions between the structural polypeptides. The network is dispersed throughout an immobilized aqueous phase. The hydrophilicity and stability of the hydrogel permits the penetration and absorption of water (swelling) without dissolving, thus, maintaining its three-dimensional (3D) structure and function.

A preferred embodiment of a hydrogel is a flowable hydrogel. The term “flowable hydrogel”, as used herein, refers to a hydrogel that is capable of flowing, in particular when it is exposed to the force of gravity. A flowable hydrogel is in a liquid state (in the sense that it is not yet self-supporting, meaning that it retain a shape imparted to it without shape-stabilizing encasement). The followability of a hydrogel can easily be determined by the skilled person, e.g. by rheology or viscosity measurements. The followability measurements are preferably preformed under standard conditions (20° C.). Methods for determining the viscosity of gels are described in detail in the following.

Alternatively, the hydrogel is a non-flowable hydrogel. This hydrogel can be converted to a flowable hydrogel by shear-thinning. The same holds for structural polypeptides in the sense of the invention that are in a solid form.

Preferably, the structural polypeptide employed according to the invention is in the form of a hydrogel. More preferably, the structural polypeptide in the form of a hydrogel is a silk polypeptide. In particular, the structural polypeptide in the form of a hydrogel is a recombinant or synthetic silk polypeptide.

Preferably, the structural polypeptide employed according to the invention is in the form of a flowable hydrogel. More preferably, the structural polypeptide in the form of a flowable hydrogel is a silk polypeptide. In particular, the structural polypeptide in the form of a flowable hydrogel is a recombinant or synthetic silk polypeptide.

The hydrogel hereinafter is also referred to as silk gel. The manufacture of hydrogel is described for example in WO2020035361, WO2022258500 or WO2022258499.

In a preferred embodiment, the laundry detergent composition according to the invention comprises a structural polypeptide which can form polypeptide aggregates. In particular, said polypeptide has the potential to assemble into fibrillary structures (i.e. fibrillary aggregates (complexes) of structural polypeptides).

It is preferred that the structural polypeptide is selected from silk polypeptides, keratin, collagen, elastin and combinations thereof. In one embodiment, the silk polypeptide is fibroin. In particular, the structural polypeptide is a recombinant polypeptide, e.g. a recombinant silk polypeptide, keratin, collagen or elastin.

It is more preferred that the structural polypeptide is a silk polypeptide, in particular a recombinant silk polypeptide.

In a preferred embodiment, the (recombinant) silk polypeptide is a spider silk polypeptide. A suitable spider silk polypeptide is a major ampullate silk polypeptide, such as a dragline silk polypeptide, a minor ampullate silk polypeptide, or a flagelliform silk polypeptide of an orb-web spider. Particularly, the silk polypeptide is a spider silk polypeptide, more particularly a recombinant spider silk polypeptide.

In a preferred embodiment, the silk polypeptide comprises or consists of 25 to 4000 amino acids. It is even more preferred that the silk polypeptide comprises or consists of 30 to 1500 amino acids, in particular 35 to 1200 amino acids. in a special embodiment, the silk polypeptide comprises or consists of 60 to 600 amino acids.

In one preferred embodiment, the silk polypeptide consists of a single unit of amino acids. This embodiment is defined in that the protein chain does not have units of several (at least two) of the same or similar sequence motifs. In this embodiment, the silk polypeptide preferably consists of 25 to 250 amino acids, in particular 30 to 150 amino acids. In an alternative preferred embodiment, the silk polypeptide is a polypeptide with an amino acid sequence which comprises or consists of at least 50% multiple copies of repetitive units. The amino acid sequence may consist of up to 100% multiple copies of repetitive units. More preferably, the silk polypeptide is a polypeptide with an amino acid sequence which comprises or consists of at least 50%, particularly at least 60%, particularly at least 65%, particularly at least 70%, particularly at least 75%, particularly particularly at least 80%, particularly at least 85%, particularly at least 90%, particularly at least 95%, or especially at least 99% multiple copies of repetitive units or of even 100% multiple copies of repetitive units. Said repetitive units may be identical or different.

If the amino acid sequence of the silk polypeptide is a polypeptide that comprises or consists of multiple copies of repetitive units, each repetitive unit preferably comprises or consists of 25 to 250 amino acids, in particular 30 to 150 amino acids.

If the amino acid sequence of the silk polypeptide is a polypeptide that comprises or consists of multiple copies of repetitive units, the total number of amino acids in all repetitive units is preferably in a range of 25 to 3000 amino acids, more preferably 30 to 1500 amino acids, in particular 35 to 1200 amino acids, especially 60 to 600 amino acids.

In a preferred embodiment, the silk polypeptide comprises or consists of at least two identical repetitive units. For example, the silk polypeptide comprises or consists of from 2 to 96 repetitive units, e.g. 2, 3, 4, 5, 6, 7, 8, 9, 10, 11, 12, 13, 14, 15, 16, 17, 18, 19, 20, 21, 22, 23, 24, 25, 26, 27, 28, 29, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, or 96 repetitive units.

In particular, the repetitive units are independently selected from the group consisting of
module C having an amino acid sequence according to SEQ ID NO: 1 (GSSAAAAAAAASGPGGYGPENQGPSGPGGYGPGGP) or variants thereof,
module C^{Cys} having an amino acid sequence according to SEQ ID NO: 2 (GSSAAAAAAAASGPGGYGPENQGPCGPGGYGPGGP) or variants thereof,
module C^{Lys} having an amino acid sequence according to SEQ ID NO: 3 (GSSAAAAAAAASGPGGYGPKNQGPSGPGGYGPGGP) or variants thereof.

Module C^{Cys} (SEQ ID NO: 2) is a variant of module C (SEQ ID NO: 1). In this module, the amino acid Ser at position 25 has been replaced by the amino acid Cys. Module C^{Lys} (SEQ ID NO: 3) is also a variant of module C (SEQ ID NO: 1). In this module, the amino acid Glu at position 20 has been replaced by the amino acid Lys.

The module C variant differs from the reference module C from which it is derived by up to 1, 2, 3, 4, 5, 6, 7, 8, 9, 10, 11, 12, 13, 14 or 15 amino acid changes in the amino acid sequence (i.e. substitutions, additions, insertions, deletions, N-terminal truncations and/or C-terminal truncations). Such a module variant can alternatively or additionally be characterized by a certain degree of sequence identity to the reference module from which it is derived. Thus, the module C variant has a sequence identity of at least 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99% or even 99.9% to the respective reference module C. Preferably, the sequence identity is over a continuous stretch of at least 5, 10, 15, 18, 20, 24, 27, 28, 30, 34 or more amino acids, preferably over the whole length of the respective reference module C.

The sequence identity may be at least 80% over the whole length, may be at least 85% over the whole length, may be at least 90% over the whole length, may be at least 95% over the whole length, may be at least 98% over the whole length, or may be at least 99% over the whole length of the respective reference module C. Alternatively, the sequence identity may be at least 80% over a continuous stretch of at least 5, 10, 15, 18, 20, 24, 28, or 30 amino acids, may be at least 85% over a continuous stretch of at least 5, 10, 15, 18, 20, 24, 28, or 30 amino acids, may be at least 90% over a continuous stretch of at least 5, 10, 15, 18, 20, 24, 28, or 30 amino acids, may be at least 95% over a continuous stretch of at least 5, 10, 15, 18, 20, 24, 28, or 30 amino acids, may be at least 98% over a continuous stretch of at least 5, 10, 15, 18, 20, 24, 28, or 30 amino acids, or may be at least 99% over a continuous stretch of at least 5, 10, 15, 18, 20, 24, 28, or 30 amino acids of the respective reference module C.

A fragment (or deletion) variant of module C has preferably a deletion of up to 1, 2, 3, 4, 5, 6, 7, 8, 9, 10, 11, 12, 13, 14, or 15 amino acids at its N-terminus and/or at its C-terminus.

The deletion can also be internally.

Additionally, the module C variant or fragment is only regarded as a module C variant or fragment within the context of the present invention if the modifications with respect to the amino acid sequence on which the variant or fragment is based do not negatively affect the ability of the silk polypeptide to treat dishware in a dishwasher. The skilled person can readily assess whether the silk polypeptide comprising a module C variant or fragment is still capable of treating dishware. In this respect, it is referred to the examples comprised in the experimental part of the present patent application.

C^{Cys} or C^{Lys} variants may also be encompassed by the present invention. Regarding the C^{Cys} or C^{Lys} variants, the same explanations/definitions apply which have been made with respect to the module C variant (see above).

It is still even more preferred that the silk polypeptide is selected from the group consisting of (C)ₘ, (C)ₘC^{Cys} (C)ₘC^{Lys}, C^{Cys}(C)ₘ, C^{Lys}(C)ₘ, (C^{Cys})ₘ and (C^{Lys})ₘ, wherein m is an integer of 1 to 96.

It is most preferred that the silk polypeptide is selected from the group consisting of C₁, C₂, C₃, C₄, C₅, C₆, C₇, C₈, C₉, C₁₀, C₁₁, C₁₂, C₁₃, C₁₄, C₁₅, C₁₆, C₁₇, C₁₈, C₁₉, C₂₀, C₂₁, C₂₂, C₂₃, C₂₄, C₂₅, C₂₆, C₂₇, C₂₈, C₂₉, C₃₀, C₃₁, C₃₂, C₃₃, C₃₄, C₃₅, C₃₆, C₃₇, C₃₈, C₃₂, C₃₉, C₄₀, C₄₁, C₄₂, C₄₃, C₄₄, C₄₅, C₄₆, C₄₇, C₄₈,
(C)₁C^{Cys}, (C)₂C^{Cys}, (C)₃C^{Cys}, (C)₄C^{Cys}, (C)₅C^{Cys}, (C)₆C^{CYs}, (C)₇C^{CYs}, (C)₈C^{Cys}, (C)₉C^{Cys} (C)₁₀C^{Cys}, (C)₁₁C^{Cys}, (C)₁₂C^{Cys}, (C)₁₃C^{Cys}, (C)₁₄C^{Cys}, (C)₁₅C^{Cys}, (C)₁₆C^{Cys}, (C)₁₇C^{Cys} (C)₁₈C^{Cys}, (C)₁₉C^{Cys}, (C)₂₀C^{Cys}, (C)₂₁C^{Cys}, (C)₂₂C^{Cys}, (C)₂₃C^{Cys}, (C)₂₄C^{Cys}, (C)₂₅C^{Cys} (C)₂₆C^{Cys}, (C)₂₇C^{Cys}, (C)₂₈C^{Cys}, (C)₂₉C^{Cys}, (C)₃₀C^{Cys}, (C)₃₁C^{Cys}, (C)₃₂C^{Cys}, (C)₃₃C^{Cys} (C)₃₄C^{Cys}, (C)₃₅C^{Cys}, (C)₃₆C^{Cys}, (C)₃₇C^{Cys}, (C)₃₈C^{Cys}, (C)₃₂C^{Cys}, (C)₃₉C^{Cys}, (C)₄₀C^{Cys}, (C)₄₁C^{Cys}, (C)₄₂C^{Cys}, (C)₄₃C^{Cys}, (C)₄₄C^{Cys}, (C)₄₅C^{Cys}, (C)₄₆C^{Cys}, (C)₄₇C^{Cys}, (C)₄₈C^{Cys},
(C)₁C^{Lys}, (C)₂C^{Lys}, (C)₃C^{Lys}, (C)₄C^{Lys}, (C)₅C^{Lys}(C)₆C^{Lys}, (C)₇C^{Lys}, (C)₈C^{Lys}, (C)₉C^{Lys}, (C)₁₀C^{Lys}, (C)₁₁C^{Lys}, (C)₁₂C^{Lys}, (C)₁₃C^{Lys}, (C)₁₄C^{Lys}, (C)₁₅C^{Lys}, (C)₁₆C^{Lys}, (C)₁₇C^{Lys}, (C)₁₈C^{Lys}, (C)₁₉C^{Lys}, (C)₂₀C^{Lys}, (C)₂₁C^{Lys}, (C)₂₂C^{Lys}, (C)₂₃C^{Lys}, (C)₂₄C^{Lys}, (C)₂₅C^{Lys}, (C)₂₆C^{Lys}, (C)₂₇^{Lys}, (C)₂₈C^{Lys}, (C)₂₉C^{Lys}, (C)₃₀C^{Lys}, (C)₃₁C^{Lys}, (C)₃₂C^{Lys}, (C)₃₃C^{Lys}, (C)₃₄C^{Lys}, (C)₃₅C^{Lys}, (C)₃₆C^{Lys}, (C)₃₇C^{Lys}, (C)₃₈C^{Lys}, (C)₃₂C^{Lys}, (C)₃₉C^{Lys}, (C)₄₀C^{Lys}, (C)₄₁C^{Lys}, (C)₄₂C^{Lys}, (C)₄₃C^{Lys}, (C)₄₄C^{Lys}, (C)₄₅C^{Lys}, (C)₄₆C^{Lys}, (C)₄₇C^{Lys}, (C)₄₈C^{Lys},
C^{Cys}(C)₁, C^{Cys}(C)₂, C^{Cys}(C)₃, C^{Cys}(C)₄, C^{Cys}(C)₅, C^{Cys}(C)₆, C^{Cys}(C)₇, C^{Cys}(C)₈, C^{Cys}(C)₉, C^{Cys}(C)₁₀, C^{Cys}(C)₁₁, C^{Cys}(C)₁₂, C^{Cys}(C)₁₃, C^{Cys}(C)₁₄, C^{Cys}(C)₁₅, C^{Cys}(C)₁₆, C^{Cys}(C)₁₇, C^{Cys}(C)₁₈, C^{Cys}(C)₁₉, C^{Cys}(C)₂₀, C^{Cys}(C)₂₁, C^{Cys}(C)₂₂, C^{Cys}(C)₂₃, C^{Cys}(C)₂₄, C^{Cys}(C)₂₅, C^{Cys}(C)₂₆, C^{Cys}(C)₂₇, C^{Cys}(C)₂₈, C^{Cys}(C)₂₉, C^{Cys}(C)₃₀, C^{Cys}(C)₃₁, C^{Cys}(C)₃₂, C^{Cys}(C)₃₃, C^{Cys}(C)₃₄, C^{Cys}(C)₃₅, C^{Cys}(C)₃₆, C^{Cys}(C)₃₇, C^{Cys}(C)₃₈, C^{Cys}(C)₃₉, C^{Cys}(C)₄₀, C^{Cys}(C)₄₁, C^{Cys}(C)₄₂, C^{Cys}(C)₄₃, C^{Cys}(C)₄₄, C^{Cys}(C)₄₅, C^{Cys}(C)₄₆, C^{Cys}(C)₄₇, C^{Cys}(C)₄₈,
C^{Lys}(C)₁, C^{Lys}(C)₂, C^{Lys}(C)₃, C^{Lys}(C)₄, C^{Lys}(C)₅, C^{Lys}(C)₆, C^{Lys}(C)₇, C^{Lys}(C)₈, C^{Lys}(C)₉, C^{Lys}(C)₁₀, C^{Lys}(C)₁₁, C^{Lys}(C)₁₂, C^{Lys}(C)₁₃, C^{Lys}(C)₁₄, C^{Lys}(C)₁₅, C^{Lys}(C)₁₆, C^{Lys}(C)₁₇, C^{Lys}(C)₁₈, C^{Lys}(C)₁₉, C^{Lys}(C)₂₀, C^{Lys}(C)₂₁, C^{Lys}(C)₂₂, C^{Lys}(C)₂₃, C^{Lys}(C)₂₄, C^{Lys}(C)₂₅, C^{Lys}(C)₂₆, C^{Lys}(C)₂₇, C^{Lys}(C)₂₈, C^{Lys}(C)₂₉, C^{Lys}(C)₃₀, C^{Lys}(C)₃₁, C^{Lys}(C)₃₂, C^{Lys}(C)₃₃, C^{Lys}(C)₃₄, C^{Lys}(C)₃₅, C^{Lys}(C)₃₆, C^{Lys}(C)₃₇, C^{Lys}(C)₃₈, C^{Lys}(C)₃₉, C^{Lys}(C)₄₀, C^{Lys}(C)₄₁, C^{Lys}(C)₄₂, C^{Lys}(C)₄₃, C^{Lys}(C)₄₄, C^{Lys}(C)₄₅, C^{Lys}(C)₄₆, C^{Lys}(C)₄₇ and C^{Lys}(C)₄₈.

In one embodiment, the silk polypeptide comprises an amino terminal TAG, e.g. consisting of the amino acid sequence MASMTGGQQMG (SEQ ID NO: 4). In another embodiment, the silk polypeptide comprises an amino terminal TAG and a Linker, the Linker e.g. consisting of the amino acid sequence RGSM (SEQ ID NO: 5).

In one example, the silk polypeptide comprises 16 times module C(=C₁₆) and has the amino acid sequence according to SEQ ID NO: 6 (with a TAG according to SEQ ID NO: 4 and a Linker according to SEQ ID NO: 5 at the N-terminus).

In another example, the silk polypeptide comprises 16 CLys modules (C^{Lys}₁₆) (SEQ ID NO: 7).

In another example, the silk polypeptide comprises 17 modules, wherein the first module (N-terminal) or the last module (C-terminal) is a C^{Cys} module (SEQ ID NO: 2) and the 16 other modules are C modules (SEQ ID NO: 1). A specific example is (C)₁₆C^{Cys} (SEQ ID NO: 8)

In another example, the silk polypeptide comprises 17 modules, wherein the first module (N-terminal) or the last module (C-terminal) is a CLys module (SEQ ID NO: 3) and the 16 other modules are C modules (SEQ ID NO: 1).

Exemplarily larger silk polypeptides based on C modules are the silk polypeptide C₃₂ (32 times module C) having the amino acid sequence according to SEQ ID NO: 9 and the silk polypeptide C₄₈ (48 times module C) having the amino acid sequence according to SEQ ID NO: 10.

Particularly, the above-described silk polypeptide consists exclusively of repetitive units. In other words, the silk polypeptide particularly does not comprise/is free of non-repetitive units. The only component that can additionally be present as part of the silk polypeptide is a tag or moiety, e.g. allowing easy transcription of said silk polypeptide in expression systems and/or allowing easy isolation of said silk polypeptide from the expression systems. Said tag may be a his tag or a flag tag.

The laundry detergent composition according to the invention preferably comprising from 0.0005 to 2.5% by weight, more preferably from 0.001 to 2.0% by weight, in particular from 0.05 to 1.5% by weight, e.g. 0.0005, 0.0006, 0.0007, 0.0008, 0.0009, 0.001, 0.002, 0.003, 0.004, 0.005, 0.006, 0.007, 0.008, 0.009, 0.01, 0.02, 0.03, 0.04, 0.05, 0.06, 0.07, 0.08, 0.09, 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, 2, 2.1, 2.2, 2.3, 2.4, or 2.5 by weight, based on the total weight of the composition, of at least one structural polypeptide (component a)).

For the formulation of the laundry detergent composition the structural polypeptide a) can be employed in solid form, e.g. in the form of a powder. The structural polypeptide a) can also be employed in form of a solution. Preferred solvents are water, at least partly water-miscible organic solvents and mixtures thereof. The structural polypeptide a) can also be employed in form of a gel. The gel form preferably comprises the structural polypeptide in an amount of 0.5 to 30% by weight, more preferably 1 to 20% by weight, e.g. 0.5, 0.6, 0.7, 0.8, 0.9, 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 by weight, based on the total weight of the gel.

### Surfactant (Component b)

Suitable surfactants b) are anionic surfactants, nonionic surfactants, cationic surfactants, amphoteric surfactants and mixtures thereof.

Preferably, the laundry detergent composition comprises at least one anionic surfactant b1). In a special embodiment, the laundry detergent composition comprises as surfactants exclusively anionic surfactants b1).

In another special embodiment, the laundry detergent composition comprises
b1) at least one anionic surfactant, and
b2) optionally at least one nonionic surfactant.

Preferably, the laundry detergent composition comprises from 3 to 60% by weight, more preferably from 5 to 50% by weight, in particular from 7 to 45% by weight, based on the total weight of the composition, of at least one anionic surfactant b1).

If the laundry detergent composition is formulated as a concentrate, it preferably comprises from 10 to 60% by weight, more preferably from 20 to 60% by weight, based on the total weight of the composition, of at least one anionic surfactant b1).

Preferably, the laundry detergent composition comprises from 0 to 40% by weight, more preferably from 1 to 30% by weight, in particular from 2.5 to 25% by weight, based on the total weight of the composition, of at least one nonionic surfactant b2).

Suitable anionic surfactants b) are alkylbenzenesulfonates, soaps, olefinsulfonates, fatty acid ester sulfonates, sulfonated fatty acids, alkyl sulfates, mono- and dialkyl sulfosuccinates, mono- and dialkyl sulfosuccinamates, sulfotriglycerides, amide soaps, ether carboxylic acids and salts thereof, acyl isethionates, acyl sarcosinates, acyl taurates, acyl methyltaurates, alkylsuccinic acids, N-acylamino acids, acyl tartrates, acyl glutamates, acyl aspartates, alkyl polyglucoside sulfates, alkylglucose carboxylates, protein fatty acid condensates and alkyl (ether) phosphates.

Suitable anionic surfactants b) are also surfactants containing polyether groups, preferably selected from alkyl polyether sulfates, aryl polyether sulfates, alkylaryl polyether sulfates, alkyl polyether sulfonates, aryl polyether sulfonates, alkylaryl polyether sulfonates, alkyl polyether phosphates, aryl polyether phosphates, alkylaryl polyether phosphates, glyceryl ether sulfonates, glyceryl ether sulfates, monoglyceride (ether) sulfates, fatty acid amide ether sulfates and mixtures thereof. The polyether groups are generally derived from ethylene oxide (EO), 1,2-propylene oxide (PO), 1,2-butylene oxide (BO), 1,2-pentylene oxide and mixtures thereof. The polyether groups are preferably derived from ethylene oxide and mixtures of ethylene oxide and propylene oxide. Different alkylene oxide groups may be randomly distributed or arranged in blocks. In a special embodiment, the polyether groups are exclusively derived from ethylene oxide (EO).

The anionic surfactants can be added to the laundry detergent composition in the form of salts. Suitable cations in these salts are alkali metal ions, such as sodium, potassium, lithium and ammonium cations. Suitable ammonium cations are for example hydroxyalkylammonium, di(hydroxyalkyl)ammonium and tri(hydroxyalkyl)ammonium, in particular hydroxyethylammonium, di(hydroxyethyl)ammonium and tri(hydroxyethyl)ammonium salts. A special embodiment are the monoethanolamine salts (MEA salts), e.g. LAS MEA salts.

Examples of suitable alkylbenzenesulfonates b1) are linear alkylbenzenesulfonates (“LAS”) and alkyltoluenesulfonates. Preferred are linear C₈- to C₂₂-alkylbenzenesulfonates, more preferably linear C₉- to C₂₀-alkylbenzenesulfonates. A special embodiment are the sodium and potassium salts of linear C₁₁- to C₁₅-alkyl benzene sulphonates.

In the context of this application the term soap denotes salts of fatty acids. Suitable fatty acids are linear or branched, preferably having from 8 to 24 carbon atoms, more preferably from 10 to 20 carbon atoms. The average carbon chain length for fatty acid soaps is preferably from 12 to 18 carbon atoms, more preferably from 14 to 16 carbon atoms. Preferred salts of the fatty acids are alkali metal salts, ammonium salts and hydroxyalkyl ammonium salts, such as sodium and potassium, especially sodium salts. The fatty acids of the soaps can be obtained from natural sources, such as plant or animal esters; examples include coconut oil, palm oil, palm kernel oil, olive oil, peanut oil, corn oil, sesame oil, rice bran oil, cottonseed oil, babassu oil, soybean oil, castor oil, tallow, fish oil, grease, lard, and mixtures thereof. Preferred fatty acids are obtained from coconut oil, tallow, palm oil (palm stearin oil), palm kernel oil, and mixtures thereof. Suitable fatty acids can also be synthetically prepared, for example, by the oxidation of petroleum, or by hydrogenation of carbon monoxide by the Fischer-Tropsch process. Examples of useful soaps are the sodium and potassium salts of the mixtures of fatty acids derived from coconut oil and tallow, i.e. sodium and potassium tallow and coconut soaps.

In the context of this application the term olefinsulfonates also encompasses olefindisulfonates. Suitable olefinsulfonates b1) are C₈- to C₂₄-olefinsulfonates and -disulfonates. Suitable are also mixtures of alkenesulfonates and hydroxyalkanesulfonates and/or the corresponding disulfonates.

Examples of suitable fatty acid ester sulfonates b1) are sulfonated fatty acid methyl ester (FAME sulfonates).

Examples of suitable alkylsulfates b1) are fatty alcohol sulfates of fatty alcohols having preferably from 8 to 22, more preferably from 10 to 18 carbon atoms. The alcohol moiety can be derived from a certain alcohol having a specific number of carbon atoms within the above-mentioned range of carbon atoms or mixtures of alcohols in the above-mentioned range. In special embodiments, the alkylsulfates b1) are selected from C₉-C₁₁-alcohol sulfates, C₁₂-C₁₄-alcohol sulfates, C₁₂-C₁₈-alcohol sulfates, lauryl sulfate, cetyl sulfate, myristyl sulfate, palmityl sulfate, stearyl sulfate and tallow fatty alcohol sulfate. In a special embodiment, the anionic surfactant b1) comprises or consists of sodium dodecyl sulfate (SDS).

Examples of N-acylamino acids b1) are acyl lactylates.

Examples of suitable alkyl polyether sulfates b1) (also denoted as alkyl ether sulfates, AES) are sulfated alkoxylated C₈- to C₂₂-alcohols, preferably C₁₀- to C₁₈-alcohols, and their salts. One embodiment are sulfated ethoxylated C₈- to C₂₂-alcohols, preferably C₁₀- to C₁₈-alcohols, and their salts. Examples of a special alkyl polyether sulfates b1) are sodium dodecyl poly(oxyethylene) sulfate (sodium lauryl ether sulfate, SLES) and the monoethanolamine salt of ethoxylated lauryl sulfate (MEA-Laureth sulfate).

In a special embodiment, the anionic surfactant b1) is selected from alkylbenzenesulfonates, soaps, alkyl sulfates, alkyl polyether sulfates and mixtures thereof. Suitable as nonionic surfactant b2) are in general nonionic surfactants having at least one nonpolar group and at least one polar group and comprising a polyether group. They can be obtained by the modification of a hydrophobic compound with hydrophilic alkylene oxide moieties. Generally, any hydrophobic compound having a hydroxyl, carboxyl, amino or amido group with a reactive hydrogen atom can be condensed with alkylene oxides, or a polyhydration product thereof, to form a nonionic surface-active agent. The alkylene oxide is preferably selected from ethylene oxide (EO), 1,2-propylene oxide (PO), 1,2-butylene oxide (BO), 1,2-pentylene oxide and mixtures thereof. The ether component here may be derived from random copolymers and block copolymers. In a preferred embodiment, the alkylene oxide is selected from ethylene oxide and mixtures of ethylene oxide with propylene oxide and/or butylene oxide.

The nonionic surfactants b2) are preferably selected from alkyl polyoxyalkylene ethers, EO/PO block copolymers from polyvalent initiators, alkoxylated animal and/or vegetable fats and/or oils, fatty amine alkoxylates, ethoxylated polyethyleneimine, fatty acid amide alkoxylates, fatty acid diethanolamide alkoxylates, polyoxyethylene sorbitan fatty acid esters, rhamnolipids, sophorolipds and mixtures thereof.

In one embodiment, the nonionic surfactants b2) are selected from alkoxylated alcohols. Suitable nonionic surfactants b2) are condensation products of one mole of a saturated or unsaturated, straight-chain or branched alcohol having from 1 to 30 carbon atoms, preferably 4 to 24 carbon atoms, in particular from 8 to 22 carbon atoms. The starting alcohol can be naturally derived, e.g. from natural oils or fats, or synthetically derived, e.g. alcohols obtained from the Oxo-process, Fischer-Tropsch process or Guerbet reaction.

Guerbet alcohols are a class of alcohols with branching at the β-position. The alkoxylate chain may be derived from ethylene oxide units, 1,2-propylene oxide units, 1,2-butylene oxide units, 1,4-butylene oxide units 1,2-pentylene oxide units and mixtures thereof. In alkoxylate chains based on two or more different alkylene oxides, the alkylene oxid units may be randomly distributed or arranged in blocks. In one embodiment the alkoxylate chain is made up solely of ethoxylate groups. In another embodiment the alkoxylate chain comprises ethoxylate groups and propoxylate and/or buthoxylate groups. The alkoxylated alcohols b2) preferably have alkylene oxide chains with 1 to 100 moles, preferably 2 to 50 moles, in particular 3 to 25 alkylene oxide units.

Examples of commercially available compounds of this type include a ethoxylated C₁₃-rich iso-C₁₁-C₁₄ alcohol, e.g. Genapol® X089 marketed by Clariant. Further examples are C₁₆C₁₈ fatty alcohol ethoxylates, commercially available as Lutensol® AT brands from BASF SE. Further examples are C₁₃C₁₅ oxo alcohol ethoxylates, commercially available as Lutensol® AO brands from BASF SE. Further examples are C₁₀C₁₈ alcohol ethoxylates, commercially available as Lutensol® M brands from BASF SE. Further examples are C₁₃ oxoalcohol ethoxylates, commercially available as Lutensol® TO brands from BASF SE. Further examples are Guerbetalcohol alkoxylates, commercially available as Lutensol® XP and XL brands from BASF SE.

In another embodiment, the nonionic surfactants b2) are selected from condensation products of one mole of a saturated or unsaturated, straight-chain or branched alcohol having from 6 to 30 carbon atoms, preferably 8 to 24 carbon atoms, with ethylene oxide and at least one further alkylene oxide, selected from propylene oxide, butylene oxide and mixtures thereof. Preferred are ethoxylated and propoxylated and/or butoxylated C₆-C₁₈ fatty alcohols. The degree of ethoxylation is preferably from 2 to 50, more preferably from 3 to 30. The degree of propoxylation is preferably from 1 to 10, more preferably of from 1 to 5, in particular 1, 2 or 3. The degree of butoxylation, if present, is preferably 1 or 2, in particular 1.

Examples of commercially available compounds of this type include certain Genapol® surfactants marketed by Clariant, e.g. Genapol® EP 2454, a lauryl alcohol EO/PO adduct, or Genapol® EP 2464, a C₁₂/C₁₅ oxoalcohol EO/PO addition product. Further examples are EP/PO, EO/PO/EO and PO/EO/PO block copolymers, commercially available as Pluronic® PE and RPE brands from BASF SE.

In another embodiment, the nonionic surfactants b2) are selected from EO/PO block copolymers based upon at least one polyvalent initiator, preferably selected from ethylene glycol, propylene glycol, glycerol, trimethylolpropane, ethylenediamine, polyethyleneimines and mixtures thereof. Suitable as nonionic surfactants b2) are also tetrafunctional block copolymers derived from the sequential addition of propylene oxide and ethylene oxide to ethylenediamine. The number average molecular weight of the propylene oxide units ranges from about 500 to about 7000, and the number average molecular weight of the hydrophilic ethylene oxide units ranges from about 10% by weight to about 80% by weight of the molecule. Examples of commercially available compounds of this type include the Tetronic® compounds, marketed by BASF SE.

Suitable as nonionic surfactants b2) are also polyoxyalkylene ether containing hydroxyl groups and polyoxyalkylene esters. These include, for example, lauryl alcohol polyoxyethylene acetate.

Suitable as nonionic surfactant b2) are further ethoxylated polyethyleneimines. Suitable ethoxylated polyethylenimine polymers comprise a polyethyleneimine backbone modified by an ethoxylation of the nitrogen atoms. Depending on whether an internal or a terminal nitrogen atom is ethoxylated, the polymer includes one or two ethoxylation modification(s) per nitrogen atom. The total degree of ethoxylation is preferably in a range of from 1 to 200, more preferably 2 to 150, in particular 5 to 100. Optionally, the nitrogen atoms can be partly or fully quaternized. The degree of quaternization is preferably 0 to 50%, e.g. 0.1 to 40% or 0.5 to 30%.

Suitable as nonionic surfactants b2) are also alkoxylated animal and/or vegetable fats and/or oils, for example corn oil ethoxylates, castor oil ethoxylates, tallow fat ethoxylates, fatty amine alkoxylates, fatty acid amide and fatty acid diethanolamide alkoxylates, especially ethoxylates thereof, and polyoxyalkylene sorbitan fatty acid esters.

Suitable nonionic surfactants b2) are further glyceryl esters, for example glyceryl monostearate, sugar surfactants, sorbitol esters, for example sorbitan fatty acid esters (sorbitan monooleate, sorbitan tristearate), polyoxyethylenesorbitan fatty acid esters, alkyl polyglycosides, N-alkylgluconamides, alkyl methyl sulfoxides, alkyldimethylphosphine oxides, for example tetradecyldimethylphosphine oxide.

Suitable surfactants b) are also amphoteric surfactants b3). In the context of this application, amphoteric surfactants also encompass zwitterionic surfactants. Suitable amphoteric surfactants b3) are, for example, alkyl betaines, alkylamidopropyl betaines, alkyl sulfobetaines, alkyl glycinates, alkyl carboxyglycinates, alkyl amphoacetates or alkyl amphopropionates, alkyl amphodiacetates or alkyl amphodipropionates. For example, it is possible to use cocodimethylsulfopropyl betaine, lauryl betaine, cocamidopropyl betaine, sodium cocamphopropionate or tetradecyldimethylamine oxide.

A special embodiment of the surfactant b3) are zwitterionic polyamines. Suitable zwitterionic polyamines are those described in EP3342847A1, which are incorporated herein by reference. Suitable are further zwitterionic quaternized hexamethylene diamines as those described in WO 01/62882 A1, which are incorporated herein by reference.

Preferably, the laundry detergent composition comprises from 0 to 10.0% by weight, more preferably from 0.1 to 7.0% by weight, in particular from 0.5 to 5.0% by weight, based on the total weight of the composition, of at least one amphoteric surfactant b3).

Suitable surfactants b) are also cationic surfactants b4). Suitable cationic surfactants b4) include, for example, quaternized ammonium compounds, especially alkyltrimethylammonium and dialkyldimethylammonium halides and alkylsulfates, and pyridine and imidazoline derivatives, especially alkylpyridinium halides. For example, it is possible to use behenyl- or cetyltrimethylammonium chloride.

Preferably, the laundry detergent composition comprises from 0 to 10.0% by weight, more preferably from 0.1 to 7.0% by weight, in particular from 0.5 to 5.0% by weight, based on the total weight of the composition, of at least one cationic surfactant b4).

### Component c) (Builder)

The laundry detergent composition according to the invention may comprise at least one builder (=component c)).

Builders (also chelating agents or sequestering agents) are generally components that improve the performance of surfactants in detergents by removing metal ions from the washing liquor, mainly calcium and magnesium, thus decreasing the hardness of water and reducing the formation of insoluble salts. Additionally, they may have one or more functions of, for example, a dispersing action, an anti-redeposition action, etc.

In one embodiment, the laundry detergent composition according to the invention comprises at least one builder (component c)). Preferably, the laundry detergent composition comprises at least one builder in an amount of at least 0.1% by weight, more preferably at least 0.5% by weight, in particular at least 1% by weight, based on the total weight of the composition.

The maximum amount of builders contained in the laundry detergent compositions of the invention depends on the type of formulation.

In one preferred embodiment, the laundry detergent composition is liquid and comprises at least one builder in an amount from 0.1 to 20% by weight, more preferably from 0.5 to 15% by weight, in particular from 1.0 to 10% by weight, based on the total weight of the composition.

In another preferred embodiment, the laundry detergent composition according to the invention is a fully liquid unit dose article and comprises at least one builder in an amount from 0.1 to 10% by weight, more preferably from 0.2 to 7.5% by weight, in particular from 0.5 to 5.0% by weight, based on the total weight of the composition.

In another preferred embodiment, the laundry detergent composition according to the invention is a solid unit dose article and comprises at least one builder in an amount from 5 to 80% by weight, more preferably from 10 to 65% by weight, in particular from 15 to 50% by weight, based on the total weight of the composition. In a special embodiment, the solid unit dose article comprises at least one aluminosilicate, in particular at least one zeolite, as builder.

Suitable builders may be organic or inorganic builders. Examples of suitable classes of builders are hydroxycarboxylic acids and salts thereof, polyhydroxycarboxylic acids (sugar acids) and salts thereof, phosphonic acids and salts thereof, preferably hydroxyalkylphosphonic acids, aminophosphonic acids and the salts thereof, aminopolycarboxylic acids and salts thereof, polycarboxylic acids and salts thereof, containing carboxylic acid groups and salts thereof, aluminosilicates, alkaline silicates, inorganic carbonates, phosphates and polyphosphates, and mixtures thereof.

Suitable organic builders are also hydroxycarboxylic acids and polyhydroxycarboxylic acids (sugar acids) and the salts of (poly)hydroxycarboxylic acids. These include C₄-C₂₀-hydroxycarboxylic acids, for example malic acid, tartaric acid, gluconic acid, mucic acid, lactic acid, glutaric acid, citric acid, tartronic acid, glucoheptonic acid, lactobionic acid, and sucrosemono-, -di- and tricarboxylic acid. Preferred is citric acid and salts thereof. A preferred salt is sodium citrate.

Suitable organic builders are further phosphonic acids and the salts thereof, for example hydroxyalkylphosphonic acids, aminophosphonic acids and the salts thereof. These include, for example, phosphonobutanetricarboxylic acid, aminotris(methylenephosphonic acid) (ATMP), ethylenediamine tetramethylenephosphonic acid (EDTMP), hexamethylene-diamine tetramethylenephosphonic acid (HDTMP), diethylenetriamine-pentamethylenephosphonic acid (DTPMP), morpholinomethanediphosphonic acid, 1-hydroxyethane-1,1-diphosphonic acid (HEDP) and mixtures thereof. Preferred is 1-hydroxyethane-1,1-diphosphonic acid and salts thereof.

Suitable organic builders are further aminopolycarboxylic acids, such as nitrilotriacetic acid (NTA), nitrilomonoacetic dipropionic acid, nitrilotripropionic acid, (3-alaninediacetic acid (0-ADA), ethylenediaminetetraacetic acid (EDTA), diethylenetriaminepentaacetic acid, 1,3-propylenediaminetetraacetic acid, 1,2-propylenediaminetetraacetic acid, N-(alkyl)ethylenediaminetriacetic acid, N (hydroxyalkyl)ethylenediaminetriacetic acid, ethylenediaminetriacetic acid, cyclohexylene-1,2-diaminetetraacetic acid, iminodisuccinic acid, ethylenediaminedisuccinic acid, serinediacetic acid, isoserinediacetic acid, L-asparaginediacetic acid, L-glutaminediacetic acid (GLDA), methylglycinediacetic acid (MGDA), and the salts of the aforementioned aminopolycarboxylic acids, and mixtures thereof. Preferred are ethylenediaminetetraacetic acid (EDTA) and salts thereof, L-glutaminediacetic acid (GLDA) and salts thereof, methylglycinediacetic acid (MGDA) and salts thereof, and mixtures thereof.

Suitable organic builders are further iminodisuccinic acid (IDS), ethylenediamine-N,N′-disuccinic acid (EDDS), oxydisuccinic acid, aminopolycarboxylates, alkyl polyaminocarboxylates, aminopolyalkylenephosphonates, polyglutamates, hydrophobically modified citric acid, for example agaric acid, poly-α-hydroxyacrylic acid, N-acylethylenediamine triacetates such as lauroylethylenediamine triacetate and alkylamides of ethylenediaminetetraacetic acid, such as EDTA tallow amide.

Suitable organic builders are further C₄-C₃₀-di-, -tri- and -tetracarboxylic acids, for example succinic acid, itaconic acid, propanetricarboxylic acid, butanetetracarboxylic acid, cyclopentanetetracarboxylic acid, and alkyl- and alkenylsuccinic acids having C₂-C₂₀-alkyl or -alkenyl radicals.

Suitable inorganic builders c) are, for example, crystalline or amorphous aluminosilicates having ion-exchanging properties, such as zeolites. Various types of zeolites are suitable, especially zeolites A, X, Y, P (also known as zeolite B), MAP and HS. The zeolites can be in the sodium form or in forms in which Na has been partially exchanged for other cations, such as Li, K, Ca, Mg or ammonium. In a special embodiment, the laundry detergent composition according to the invention is a solid unit dose article and comprises at least one aluminosilcate in an amount from 5 to 80% by weight, more preferably from 10 to 65% by weight, in particular from 15 to 50% by weight, based on the total weight of the composition.

Suitable inorganic builders c) are further crystalline or amorphous silicates, for example, metasilicates, disilicates or sheet silicates, e.g. layered sodium disilicate 6-Na₂Si₂O₅ (SKS 6 or SKS 7 from Weyl Chem). The silicates can be used in the form of their alkali metal, alkaline earth metal or ammonium salts, preferably as sodium, lithium and magnesium silicates.

Suitable inorganic builders are further carbonates and hydrogencarbonates. These can be used in the form of their alkali metal, alkaline earth metal or ammonium salts. Preference is given to using sodium, lithium and magnesium carbonates or sodium, lithium and magnesium hydrogencarbonates, especially sodium carbonate and/or sodium hydrogencarbonate.

Alternatively or in addition to the aforementioned builders, the laundry detergent composition may contain at least one polymeric builder. In one embodiment, the laundry detergent composition comprises at least one polymeric builder in an amount from 0.1 to 10% by weight, more preferably from 0.2 to 7.5% by weight, in particular from 0.3 to 5.0% by weight, based on the total weight of the composition.

Suitable polymeric builders are polymeric compounds containing carboxylic acid groups. An example are acrylic acid homo- and copolymers and the salts thereof. Acrylic acid homopolymers preferably have a number-average molecular weight in the range from 800 to 70 000 g/mol, more preferably from 900 to 50 000 g/mol, particularly from 1000 to 20 000 g/mol. The term “acrylic acid homopolymer” also comprises polymers in which some or all carboxylic acid groups are in neutralized form.

Suitable polymeric builders are further oligomaleic acids and the salts thereof.

Suitable polymeric builders are further copolymers of unsaturated C₄-C₈-dicarboxylic acids, for example, maleic acid, fumaric acid, itaconic acid and citraconic acid, with comonomeres, e.g. monoethylenically unsaturated C₃-C₈-monocarboxylic acids, for example acrylic acid, methacrylic acid, crotonic acid and vinylacetic acid, monoethylenically unsaturated C₂-C₂₂-olefins, vinyl alkyl ethers having C₁-C₈-alkyl groups, styrene, vinyl esters of C₁-C₈-carboxylic acids, (meth)acrylamide, vinylpyrrolidone, (meth)acrylic esters of C₁-C₆ alcohols, (meth)acrylonitrile, (meth)acrylamides of C₁-C₈ amines, N-vinylformamide and N-vinylimidazole.

Suitable polymeric builders are further copolymers of maleic acid and acrylic acid, copolymers of itaconic acid and acrylic acid, terpolymers of maleic acid, acrylic acid and a vinyl ester of a C₁-C₃-carboxylic acid and copolymers of maleic acid with C₂-C₈-olefins, e.g. ethylene, propylene or isobutene.

Suitable polymeric builders are further copolymers C₃-C₆-monocarboxylic acids, such as acrylic acid and methacrylic acid with ethylenically unsaturated sulfonic acids, such as 2-acrylamido-2-methyl-1-propane sulfonic acid (AMPS), 2-methacrylamido-2-methyl-1-propanesulfonic acid, 2-methacrylamido-2-hydroxypropanesulfonic acid, allylsulfonic acid, methallylsulfonic acid, allyloxybenzenesulfonic acid, methallyloxybenzenesulfonic acid, 2-hydroxy-3-(2-propenyloxy)propanesulfonic acid, 2-methyl-2-propene-1-sulfonic acid, styrenesulfonic acid, vinylsulfonic acid, 3-sulfopropyl acrylate, 3-sulfopropyl methacrylate and salts of these acids. A preferred embodiment are copolymers of acrylic acid and 2-acrylamido-2-methyl-1-propane sulfonic acid (AMPS) (commercially available under the tradename ACUSOL 588 from Dow Chemical Company).

Suitable polymeric builders are further graft polymers of unsaturated carboxylic acids onto low molecular weight carbohydrates or hydrogenated carbohydrates. Suitable graft bases are degraded polysaccharides, for example acidically or enzymatically degraded starches, inulins or cellulose, protein hydrolyzates and reduced (hydrogenated or hydrogenatingly aminated) degraded polysaccharides.

Suitable polymeric builders are further polyglyoxylic acids, polyamidocarboxylic acids, modified polyamidocarboxylic acids, polyaspartic acids or cocondensates of aspartic acid with further amino acids, C₄-C₂₅ mono- or -dicarboxylic acids and/or C₄-C₂₅ mono- or -diamines.

A preferred class of polymeric builders are polymeric compounds containing carboxylic acid groups. In particular preferred as builders are polyacrylic acid homo and copolymers that can be in partly or fully neutralized form.

An example of a preferred embodiment for a builder system for a liquid laundry detergent composition comprises one or more than one of the following components in a total amount of 1.0 to 10% by weight, based on the total weight of the composition:
at least one (poly)hydroxycarboxylic acid or a salt thereof, preferably citric acid or a citrate, in particular sodium citrate,
at least one aminopolycarboxylic acid or a salt thereof, preferably selected from methylglycinediacetic acid (MGDA) and salts thereof, ethylenediaminetetraacetic acid (EDTA) and salts thereof and L-glutaminediacetic acid (GLDA) and salts thereof,
at least one phosphonic acid and/or a salt thereof, preferably selected from aminotris(methylenephosphonic acid) (ATMP), ethylenediamine tetramethylenephosphonic acid (EDTMP), hexamethylenediamine tetramethylenephosphonic acid (HDTMP), diethylenetriamine-pentamethylenephosphonic acid (DTPMP), morpholinomethanediphosphonic acid, 1-hydroxyethane-1,1-diphosphonic acid (HEDP) and mixtures thereof,
at least on inorganic builder selected from silicates, carbonates, hydrogencarbonates and mixtures thereof.

An example of a preferred embodiment for a builder system for a fully liquid unit dose laundry detergent composition comprises one or more than one of the following components in a total amount of from 0.1 to 3.0% by weight, based on the total weight of the composition:
at least one phosphonic acid and/or a salt thereof, preferably selected from aminotris(methylenephosphonic acid) (ATMP), ethylenediamine tetramethylenephosphonic acid (EDTMP), hexamethylenediamine tetramethylenephosphonic acid (HDTMP), diethylenetriamine-pentamethylenephosphonic acid (DTPMP), morpholinomethanediphosphonic acid, 1-hydroxyethane-1,1-diphosphonic acid (HEDP) and mixtures thereof,
at least on inorganic builder selected from silicates, carbonates, hydrogencarbonates and mixtures thereof,
at least one aminopolycarboxylic acid or a salt thereof, preferably selected from methylglycinediacetic acid (MGDA) and salts thereof, ethylenediaminetetraacetic acid (EDTA) and salts thereof and L-glutaminediacetic acid (GLDA) and salts thereof.

An example of a preferred embodiment for a builder system for a solid unit dose laundry detergent composition comprises from 15 to 50% by weight, based on the total weight of the composition, at least one aluminosilicate, in particular at least one zeolite.

### Component d) (Enzyme)

The laundry detergent composition according to the invention may comprise at least one enzyme (=component d)).

Suitable enzymes are those typically used as industrial enzymes. These include in particular enzymes having optimal activity in the neutral to alkaline pH range.

If the laundry detergent composition comprises at least one enzyme, the amount of enzyme protein is preferably at least 0.001% by weight, more preferably at least 0.01% by weight, in particular at least 0.05% by weight, based on the total weight of the composition.

The laundry detergent composition according to the invention preferably comprises at least one enzyme in an amount of from 0.001 to 10% by weight, more preferably from 0.005 to 8% by weight, in particular from 0.01 to 5% by weight, enzyme protein based on the total weight of the composition.

Often, enzymes are employed in dishwashing formulations not in form of the pure active enzyme protein but in combination with a carrier and/or in encapsulated form and optionally with further additives. The afore-mentioned amounts refer to the active enzyme protein without any further components.

The enzymes are preferably selected from aminopeptidases, amylases, arabinases, carbohydrases, carboxypeptidases, catalases, cellulases, chitinases, cutinases, cyclodextrin glycosyltransferases, deoxyribonucleases, esterases, galactanases, alpha-galactosidases, beta-galactosidases, glucanases, glucoamylases, alpha-glucosidases, beta-glucosidases, haloperoxidases, hydrolases, invertases, isomerases, keratinases, laccases, lipases, mannanases, mannosidases, oxidases, pectinolytic enzymes, peptidoglutaminases, peroxidases, peroxygenases, phytases, polyphenol oxidases, proteolytic enzymes, ribonucleases, transglutaminases, transferases, xylanases and mixtures thereof.

In particular, the laundry detergent composition comprises one or more enzymes selected from amylases, arabinases, carbohydrases, cellulases (e.g. endoglucanases), cutinases, deoxyribonucleases, galactanases, haloperoxygenases, lipases, mannanases, oxidases (e.g. laccases and/or peroxidases), pectinases, pectin lyases, proteases, xylanases, xanthanases, xyloglucanases, oxidoreductase and mixtures thereof. Preferably, the laundry detergent composition comprises at least one enzyme selected from amylases, arabinases, carbohydrases, cellulases, galactanases, lipases, mannanases, pectinases, pectin lyases, proteases and mixtures thereof.

In a special embodiment, the laundry detergent composition comprises at least one amylase. When the composition comprises at least one amylase and at least one additional enzyme, the additional enzyme is preferably a protease and/or a lipase.

### Proteases

The composition may comprise one or more proteases including those of bacterial, fungal, plant, viral or animal origin. Proteases of microbial origin are preferred. The protease may be an alkaline protease, such as a serine protease or a metalloprotease. A serine protease may for example be of the Si family, such as trypsin, or the S8 family such as subtilisin. A metalloprotease may for example be a thermolysin from, e.g., family M4 or another metalloprotease such as those from M5, M7 or M8 families.

Examples of metalloproteases are the neutral metalloproteases as described in WO 2007/044993 (Genencor Int.) such as those derived from Bacillus amyloliquefaciens.

Suitable commercially available protease enzymes include those sold under the trade names Alcalase®, Duralase™, Durazym™, Relase®, Relase® Ultra, Savinase®, Savinase® Ultra, Primase®, Polarzyme®, Kannase®, Liquanase®, Liquanase® Ultra, Ovozyme®, Coronase®, Coronase® Ultra, Blaze®, Blaze Evity® 100T, Blaze Evity® 125T, Blaze Evity® 150T, Neutrase®, Everlase®, Esperase®, Progress® Uno and Progress® Excel (Novozymes A/S), those sold under the tradenames Maxatase®, Maxacal®, Maxapem®, Purafect®™, Purafect® Ox, Purafect® OxP, Purafect Prime®, Puramax®, FN2®, FN3®, FN4R, Excellase®, Excellenz P1000™, Excellenz P1250™, Eraser®, PreferenzR P100, Preferenz® P110, Effectenz P1000™, Effectenz P1050™, Effectenz P2000™, Purafast®, Properase®, Opticlean® and Optimase® (Danisco/DuPont), Axapem™ (Gist-Brocases N.V.), BLAP (sequence shown in FIG. 29 of U.S. Pat. No. 5,352,604) and variants hereof (Henkel AG) and KAP (Bacillus alkalophilus subtilisin) from Kao.

### Lipases and Cutinases

Suitable lipases and cutinases include those of bacterial or fungal origin, including chemically modified or protein engineered mutant enzymes. Examples include lipase from Thermomyces, e.g., from T. lanuginosus (previously named Humicola lanuginosa) as described in EP 258068 and EP 305216, cutinase from Humicola, e.g., H. insolens (WO 96/13580), lipase from strains of Pseudomonas (some of these now renamed to Burkholderia), e.g., P. alcaligenes or P. pseudoalcaligenes (EP 218272), P. cepacia (EP 331376), P. sp. strain SD705 (WO 95/06720 and WO 96/27002), P. wisconsinensis (WO 96/12012), GDSL-type Streptomyces lipases (WO 2010/065455), cutinase from Magnaporthe grisea (WO 2010/107560), cutinase from Pseudomonas mendocina (U.S. Pat. No. 5,389,536), lipase from Thermobifida fusca (WO 2011/084412), Geobacillus stearothermophilus lipase (WO 2011/084417), lipase from Bacillus subtilis (WO 2011/084599), and lipase from Streptomyces griseus (WO 2011/150157) and S. pristinaespiralis (WO 2012/137147).

Preferred commercial lipase products include Lipolase™, Lipex™; Lipolex™ and Lipoclean™ (Novozymes A/S), Lumafast (originally from Genencor) and Lipomax (originally from Gist-Brocades).

Further suitable are lipases that are referred to as acyltransferases or perhydrolases, e.g., acyltransferases with homology to Candida antarctica lipase A (WO 2010/111143), acyltransferase from Mycobacterium smegmatis (WO 2005/056782), perhydrolases from the CE 7 family (WO 2009/067279), and variants of the M. smegmatis perhydrolase, in particular the S54V variant used in the commercial product Gentle Power Bleach from Huntsman Textile Effects Pte Ltd (WO 2010/100028).

### Amylases

Suitable amylases which can be used together with the protease may be an alpha-amylase or a glucoamylase and may be of bacterial or fungal origin. Chemically modified or protein engineered mutants are included. Amylases include, for example, alpha-amylases obtained from Bacillus, e.g., a special strain of Bacillus licheniformis, described in more detail in GB 1,296,839.

Suitable amylases include amylases having SEQ ID NO: 2 in WO 95/10603 or variants having 90% sequence identity to SEQ ID NO: 3 thereof. Preferred variants are described in WO 94/02597, WO 94/18314, WO 97/43424 and SEQ ID NO: 4 of WO 99/19467, such as variants with substitutions in one or more of the following positions: 15, 23, 105, 106, 124, 128, 133, 154, 156, 178, 179, 181, 188, 190, 197, 201, 202, 207, 208, 209, 211, 243, 264, 304, 305, 391, 408, and 444.

Further suitable amylases include amylases having SEQ ID NO: 6 in WO 02/10355 or variants thereof having 90% sequence identity to SEQ ID NO: 6. Preferred variants of SEQ ID NO: 6 are those having a deletion in positions 181 and 182 and a substitution in position 193.

Further suitable amylases are hybrid alpha-amylases comprising residues 1-33 of the alpha-amylase derived from B. amyloliquefaciens shown in SEQ ID NO: 6 of WO 2006/066594 and residues 36-483 of the B. licheniformis alpha-amylase shown in SEQ ID NO: 4 of WO 2006/066594 or variants having 90% sequence identity thereof. Preferred variants of this hybrid alpha-amylase are those having a substitution, a deletion or an insertion in one of more of the following positions: G48, T49, G107, H156, A181, N190, M197, 1201, A209 and Q264. Most preferred variants of the hybrid alpha-amylase comprising residues 1-33 of the alpha-amylase derived from B. amyloliquefaciens shown in SEQ ID NO: 6 of WO 2006/066594 and residues 36-483 of SEQ ID NO: 4 are those having the substitutions:

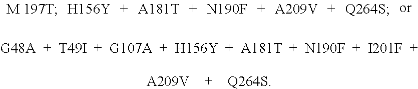

Further suitable amylases are amylases having the sequence of SEQ ID NO: 6 in WO 99/19467 or variants thereof having 90% sequence identity to SEQ ID NO: 6. Preferred variants of SEQ ID NO: 6 are those having a substitution, a deletion or an insertion in one or more of the following positions: R181, G182, H183, G184, N195, 1206, E212, E216 and K269. Particularly preferred amylases are those having deletion in positions R181 and G182, or positions H183 and G184.

Further suitable amylases which can be used are those having SEQ ID NO: 1, SEQ ID NO: 3, SEQ ID NO: 2 or SEQ ID NO: 7 of WO 96/23873 or variants thereof having 90% sequence identity to SEQ ID NO: 1, SEQ ID NO: 2, SEQ ID NO: 3 or SEQ ID NO: 7. Preferred variants of SEQ ID NO: 1, SEQ ID NO: 2, SEQ ID NO: 3 or SEQ ID NO: 7 are those having a substitution, a deletion or an insertion in one or more of the following positions: 140, 181, 182, 183, 184, 195, 206, 212, 243, 260, 269, 304 and 476, using SEQ ID 2 of WO 96/23873 for numbering. More preferred variants are those having a deletion in two positions selected from 181, 182, 183 and 184, such as 181 and 182, 182 and 183, or positions 183 and 184. Most preferred amylase variants of SEQ ID NO: 1, SEQ ID NO: 2 or SEQ ID NO: 7 are those having a deletion in positions 183 and 184 and a substitution in one or more of positions 140, 195, 206, 243, 260, 304 and 476.

Further suitable amylases which can be used are amylases having SEQ ID NO: 2 of WO 2008/153815, SEQ ID NO: 10 in WO 01/66712 or variants thereof having 90% sequence identity to SEQ ID NO: 2 of WO 2008/153815 or 90% sequence identity to SEQ ID NO: 10 in WO 01/66712. Preferred variants of SEQ ID NO: 10 in WO 01/66712 are those having a substitution, a deletion or an insertion in one of more of the following positions: 176, 177, 178, 179, 190, 201, 207, 211 and 264.

Further suitable amylases are amylases having SEQ ID NO: 2 of WO 2009/061380 or variants having 90% sequence identity to SEQ ID NO: 2 thereof. Preferred variants of SEQ ID NO: 2 are those having a truncation of the C-terminus and/or a substitution, a deletion or an insertion in one of more of the following positions: Q87, Q98, S125, N128, T131, T165, K178, R180, S181, T182, G183, M201, F202, N225, 5243, N272, N282, Y305, R309, D319, Q320, Q359, K444 and G475. More preferred variants of SEQ ID NO: 2 are those having the substitution in one of more of the following positions: Q87E,R, Q98R, S125A, N128C, T131I, T165I, K178L, T182G, M201L, F202Y, N225E,R, N272E,R, S243Q,A,E,D, Y305R, R309A, Q320R, Q359E, K444E and G475K and/or deletion in position R180 and/or S181 or of T182 and/or G183. Most preferred amylase variants of SEQ ID NO: 2 are those having the substitutions:

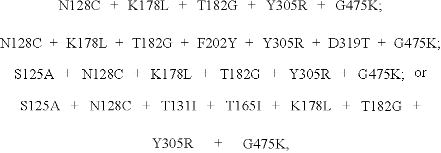

wherein the variants are C-terminally truncated and optionally further comprise a substitution at position 243 and/or a deletion at position 180 and/or position 181.

Further suitable amylases are amylases having SEQ ID NO: 1 of WO 2013/184577 or variants having 90% sequence identity to SEQ ID NO: 1 thereof. Preferred variants of SEQ ID NO: 1 are those having a substitution, a deletion or an insertion in one of more of the following positions: K176, R178, G179, T180, G181, E187, N192, M199, 1203, S241, R458, T459, D460, G476 and G477. More preferred variants of SEQ ID NO: 1 are those having the substitution in one of more of the following positions: K176L, E187P, N192FYH, M199L, I203YF, S241QADN, R458N, T459S, D460T, G476K and G477K and/or a deletion in position R178 and/or S179 or of T180 and/or G181. Most preferred amylase variants of SEQ ID NO: 1 comprise the substitutions:

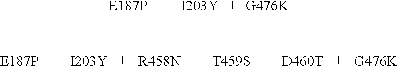

and optionally further comprise a substitution at position 241 and/or a deletion at position 178 and/or position 179.

Further suitable amylases are amylases having SEQ ID NO: 1 of WO 2010/104675 or variants having 90% sequence identity to SEQ ID NO: 1 thereof. Preferred variants of SEQ ID NO: 1 are those having a substitution, a deletion or an insertion in one of more of the following positions: N21, D97, V128 K177, R179, S180, 1181, G182, M200, L204, E242, G477 and G478.

Further suitable amylases are the alpha-amylase having SEQ ID NO: 12 in WO 01/66712 or a variant having at least 90% sequence identity to SEQ ID NO: 12. Preferred amylase variants are those having a substitution, a deletion or an insertion in one of more of the following positions of SEQ ID NO: 12 in WO 01/66712: R28, R118, N174; R181, G182, D183, G184, G186, W189, N195, M202, Y298, N299, K302, S303, N306, R310, N314; R320, H324, E345, Y396, R400, W439, R444, N445, K446, Q449, R458, N471, N484. Particularly preferred amylases include variants having a deletion of D183 and G184 and having the substitutions R118K, N195F, R320K and R458K, and a variant additionally having substitutions in one or more position selected from the group: M9, G149, G182, G186, M202, T257, Y295, N299, M323, E345 and A339, most preferred a variant that additionally has substitutions in all these positions.

Suitable commercially available amylases include Duramyl™, Termamyl™, Fungamyl™, Stainzyme™, Stainzyme Plus™, Natalase™, Liquozyme X, BAN™, Amplify® and Amplify® Prime (from Novozymes A/S), and Rapidase™, Purastar™/Effectenz™, Powerase, Preferenz S1000, Preferenz S100 and Preferenz S110 (from Genencor International Inc./DuPont).

### Deoxyribonucleases (DNases)

Suitable deoxyribonucleases (DNases) are any enzyme that catalyses the hydrolytic cleavage of phosphodiester linkages in the DNA backbone, thus degrading DNA. A DNase which is obtainable from a bacterium is preferred, in particular a DNase which is obtainable from a species of Bacillus is preferred; in particular a DNase which is obtainable from Bacillus subtilis or Bacillus licheniformis is preferred. Examples of such DNases are described in WO 2011/098579 and WO 2014/087011.

### Oxidoreductases

In one embodiment, the composition may comprise an oxidoreductase, which are enzymes that catalyse reduction-oxidation reactions. A preferred oxidoreductase is a superoxide dismutase.

The enzymes can be formulated as a separate component of the laundry detergent composition. It can be contained e.g. in a separate compartment of a multicompartment formulation or can be used in the form of an enzyme-containing film.

The laundry detergent composition preferably comprises at least one protease and/or amylase.

In a special embodiment, at least one enzyme mixture. Preference is given, for example, to enzyme mixtures comprising or consisting of the following enzymes:
protease and amylase,
protease and lipase (or lipolytic enzymes),
protease and cellulase,
amylase, cellulase and lipase (or lipolytic enzymes),
protease, amylase and lipase (or lipolytic enzymes),
protease, lipase (or lipolytic enzymes) and cellulase.

The enzymes may be adsorbed on carrier substances in order to protect them from premature breakdown. Optionally, the laundry detergent composition may also comprise enzyme stabilizers, Examples of these include calcium propionate, sodium formate, boric acids, boronic acids and salts thereof, such as 4-formylphenylboronic acid, peptides and peptide derivatives, for example peptide aldehydes, polyols such as propane-1,2-diol, and mixtures thereof.

### Polymeric Antiredeposition Agent (Component e))

The laundry detergent composition according to the invention may comprise at least one anti-redeposition polymer (=component e)).

An antiredeposition ability is the ability to prevent dirt that has once been removed by washing from the textiles being washed, from being redeposited on said textiles. Generally, polymeric builder materials like the afore-mentioned polymeric builders c) have more than one function and can also be employed as antiredeposition agents and/or soil release agents. In the following, examples of special polymeric compounds that can advantageously be used as antiredeposition agents are listed. However, further of the afore-mentioned polymeric builders c) are also suitable for this purpose.

Examples of suitable polymeric anti-redeposition agents e) are graft copolymers of polyalkylenoxides and vinyl acetate, styrene maleic anhydride copolymers, acrylic acid maleic acid copolymers and cellulosic derivatives such as hydroxyethyl cellulose, hydroxypropyl cellulose, carboxymethyl cellulose, etc.

The laundry detergent composition according to the invention preferably comprises at least one anti-redeposition agent in an amount of from 0 to 20% by weight, preferably from 0.1 to 15% by weight, in particular from 0.5 to 10% by weight, based on the total weight of the composition.

### Bleach (Component f))

In the senses of the present application, the term bleach denotes also bleach systems that possibly also comprise bleach activators, bleach catalysts and/or bleach stabilizers.

The laundry detergent composition according to the invention preferably comprises from 0 to 30% by weight, more preferably from 0 to 25% by weight, based on the total weight of the composition, of at least one bleach (component f)). If the laundry detergent composition comprises at least one bleach, then the amount is at least from 0.5% by weight, more preferably at least 1% by weight, based on the total weight of the composition. If the bleach comprises more than one component, the afore-mentioned amounts refer to the sum of all components of the bleach system.

Suitable bleaches are, for example, percarboxylic acids, for example diperoxododecanedicarboxylic acid, phthalimidopercaproic acid or monoperoxophthalic acid or -terephthalic acid, salts of percarboxylic acids, for example sodium percarbonate, adducts of hydrogen peroxide onto inorganic salts, for example sodium perborate monohydrate, sodium perborate tetrahydrate, sodium carbonate perhydrate or sodium phosphate perhydrate, adducts of hydrogen peroxide onto organic compounds, for example urea perhydrate, or of inorganic peroxo salts, for example alkali metal persulfates or peroxodisulfates.

Suitable bleach activators are, for example, polyacylated sugars, e.g. pentaacetylglucose; acyloxybenzenesulfonic acids and their alkali metal and alkaline earth metal salts, e.g. sodium p-nonanoyloxybenzenesulfonate or sodium p-benzoyloxybenzenesulfonate; N,N-diacylated and N,N,N′,Ni-tetraacylated amines, e.g. N,N,N′,N′-tetraacetylmethylenediamine and -ethylenediamine (TAED), N,N-diacetylaniline, N,N-diacetyl-p-toluidine or 1,3-diacylated hydantoins such as 1,3-diacetyl-5,5-dimethylhydantoin; N-alkyl-N-sulfonylcarbonamides, e.g. N-methyl-N-mesylacetamide or N-methyl-N-mesylbenzamide; N-acylated cyclic hydrazides, acylated triazoles or urazoles, e.g. monoacetylmaleic hydrazide; O,N,N-trisubstituted hydroxylamines, e.g. O-benzoyl-N,N-succinylhydroxylamine, O-acetyl-N,N-succinylhydroxylamine or O,N,N-triacetylhydroxylamine; N,N′-diacylsulfurylamides, e.g. N,N′-dimethyl-N,N′-diacetylsulfurylamide or N,N′-diethyl-N,N′-dipropionylsulfurylamide; acylated lactams, for example acetylcaprolactam, octanoylcaprolactam, benzoylcaprolactam or carbonylbiscaprolactam; anthranil derivatives, for example 2-methylanthranil or 2-phenylanthranil; triacyl cyanurates, e.g. triacetyl cyanurate or tribenzoyl cyanurate; oxime esters and bisoxime esters, for example O-acetylacetone oxime or bisisopropyl iminocarbonate; carboxylic anhydrides, e.g. acetic anhydride, benzoic anhydride, m-chlorobenzoic anhydride or phthalic anhydride; enol esters, for example isopropenyl acetate; 1,3-diacyl-4,5-diacyloxyimidazolines, e.g. 1,3-diacetyl-4,5-diacetoxyimidazoline; tetraacetylglycoluril and tetrapropionylglycoluril; diacylated 2,5-diketopiperazines, e.g. 1,4-diacetyl-2,5-diketopiperazine; ammonium-substituted nitriles, for example N-methylmorpholinioacetonitrile methylsulfate; acylation products of propylenediurea and 2,2-dimethylpropylenediurea, e.g. tetraacetylpropylenediurea; α-acyloxypolyacylmalonamides, e.g. α-acetoxy-N,N′-diacetylmalonamide; diacyldioxohexahydro-1,3,5-triazines, e.g. 1,5-diacetyl-2,4-dioxohexahydro-1,3,5-triazine; benz-(4H)-1,3-oxazin-4-ones with alkyl radicals, e.g. methyl, or aromatic radicals, e.g. phenyl, in the 2 position.

A bleach system composed of bleaches and bleach activators may optionally also comprise bleach catalysts. Suitable bleach catalysts are, for example, quaternized imines and sulfonimines, described, for example, in U.S. Pat. No. 5,360,569 and EP-A-453003. Particularly effective bleach catalysts are manganese complexes, described, for example, in WO 94/21777. In addition to the described bleach system composed of bleaches, bleach activators and optionally bleach catalysts, it is also possible to use systems with enzymatic peroxide release.

### Further Additives (Component g))

The laundry detergent composition according to the invention may comprise at least one additive different from components a) to f).

Suitable for the laundry detergent composition of the invention are in principle the typical additives known to a person skilled in the art. In the following suitable and preferred embodiments for some of the additives are defined in detail.

The laundry detergent composition according to the invention preferably comprises from 0 to 90% by weight, more preferably from 0 to 80% by weight, based on the total weight of the composition, of at least one additive different from components a) to f) (component g)). This amount refers to the total weight of all additives. In the following individual amounts for single additives are defined. If the laundry detergent composition comprises at least one further additive, then the amount is preferably at least 0.01% by weight, more preferably at least 0.1% by weight, based on the total weight of the composition.

The further additives are preferably selected from rheology modifier, pH controlling agents, corrosion inhibitors, defoamers, dyes, fragrances, fillers, tableting aids, disintegrants, solubilizers, electrolytes, optical brighteners, hydrotropes, antimicrobial ingredients, antioxidants and mixtures thereof.

### Rheology Modifier

In order to impart the desired viscosity to laundry detergent compositions containing a liquid and especially water, it is possible to use at least one rheology modifier. In the context of this application, the terms “rheology modifier” and “thickener” are used synonymously.

The laundry detergent composition according to the invention preferably comprises from 0 to 10% by weight, more preferably from 0 to 8% by weight, in particular from 0 to 6% by weight, based on the total weight of the composition, of at least one rheology modifier. If the laundry detergent composition comprises at least one bleach, then the amount is at least 0.1% by weight, more preferably at least 0.3% by weight, based on the total weight of the composition.

In principle, any known rheology modifiers (thickeners) are suitable, provided that they do not exert any adverse effect on the action of the dishwashing composition.

Suitable thickeners may be of natural origin or synthetic in nature.

Examples of thickeners of natural origin are xanthan, carob seed flour, guar flour, carrageenan, agar, tragacanth, gum arabic, alginates, modified starches such as hydroxyethyl starch, starch phosphate esters or starch acetates, dextrins, pectins, and cellulose derivatives such as carboxymethyl cellulose, hydroxyethyl cellulose, hydroxypropyl cellulose, hydroxypropylmethyl cellulose, methyl cellulose and the like.

Examples of synthetic thickeners are polyacrylic and polymethacrylic compounds, such as (partly) crosslinked homopolymers of acrylic acid, for example with an allyl ether of sucrose or pentaerythritol or homopolymers of acrylic acid crosslinked with propylene (Carbomer), for example the Carbopol® products from Lubrizol or the Polygel® products from 3V Sigma, copolymers of ethylenically unsaturated mono- or dicarboxylic acids, for example terpolymers of acrylic acid, methacrylic acid or maleic acid with methyl or ethyl acrylate and a (meth)acrylate which is derived from long-chain ethoxylated alcohols, for example the Acusol® products from Dow, copolymers of two or more monomers, which are selected from acrylic acid, methacrylic acid and their C₁-C₄-alkyl esters, for example copolymers of methacrylic acid, butyl acrylate and methyl methacrylate or of butyl acrylate and methyl methacrylate, for example the Aculyn® and Acusol® products from Dow, or crosslinked high molecular weight acrylic acid copolymers, for example copolymers, crosslinked with an allyl ether of sucrose or pentaerythritol, of C₁₀-C₃₀-alkyl acrylates with one or more comonomers which are selected from acrylic acid, methacrylic acid and their C₁-C₄-alkyl esters.

Suitable synthetic thickeners are also reaction products of maleic acid polymers with ethoxylated long-chain alcohols, polyethylene glycols, polyamides, polyimines and polycarboxylic acids.

Mixtures of two or more of the abovementioned thickeners are also suitable.

Preferred thickeners are xanthans and the abovementioned polyacrylic and polymethacrylic compounds.

### pH Controlling Agents

The laundry detergent composition may contain at least one pH controlling agent (pH modifying agent) to adjust the pH value of the composition and/or the pH value of the resulting rinse liquid under the use conditions of the composition. In one embodiment, the laundry detergent composition comprises at least one pH controlling agent, selected from acids, bases and pH buffer systems. The laundry detergent composition can be formulated such that during use, for example in an aqueous liquid in a dishwashing process, the rinse liquid will have a desired pH value. For example, liquid laundry detergents preferably have a pH value of 7.0 to 10.0, preferably, 7.0 to 9.0. Techniques for controlling the pH value at recommended usage levels, including the use of acids, bases, buffers, etc. are well known to those skilled in the art.

Suitable bases (also denoted as alkalinity sources or alkalinity reserve) are alkali metal hydroxides, alkaline earth metal hydroxides, alkali metal carbonates, alkaline earth metal carbonates, ammonium carbonate, alkali metal hydrogencarbonates, alkaline earth metal hydrogen carbonates, ammonium hydrogencarbonate, alkali metal silicates and mixtures thereof.

Suitable acids are carboxylic acids, hydroxycarboxylic acids and phosphoric acid. Preferably the acid is selected from citric acid, gluconic acid, tartaric acid, glucoheptonic acid, mucic acid, galactonic acid, saccharic acid, fumaric acid, succinic acid, glutaric acid, adipic acid and phosphoric acid. Particularly preferred is citric acid.

### Hydrotropes

Hydrotropes are components that function as viscosity controlling agents, gel suppressants, stability agents and/or dispersability aids. Commonly used hydrotropes include alcohols and alcohol derivatives, including glycols and alkoxylated alcohols. Suitable hydrotropes for use herein also include anionic type hydrotropes, particularly sodium, potassium and ammonium xylene sulfonate, sodium, potassium and ammonium toluene sulfonate, sodium, potassium and ammonium cumene sulfonate, dialkyl sulfosuccinates, alkyl naphthalene sulfonates and mixtures thereof. Dialkyl sulfosuccinates and alkyl naphthalene sulfonates have been mentioned before as anionic surfactants. Especially, the hydrotopes are selected from sodium cumene sulfonate, sodium xylene sulfonate, sodium toluene sulfonate, dihexyl sodium sulfosuccinate, dioctyl sodium sulfosuccinate, alkyl naphthalene sulfonates and mixtures thereof.

The laundry detergent composition of the invention preferably comprises from 0 to 15% by weight, more preferably from 0% to 12% by weight, in particular from 0% to 10% by weight, based on the total weight of the composition, of at least one hydrotrope. If the laundry detergent composition comprises at least one hydrotope, then the amount is at least 0.1% by weight, more preferably at least 0.2% by weight, in particular at least 0.5% by weight, based on the total weight of the composition.

### Optical Brighteners

The laundry detergent composition may contain an optical brightener. The optical brightener is preferably selected from hydrophobic brighteners, stilbene brighteners, biphenyl type brighteners, or a mixture thereof. Suitable brighteners include: di-styryl biphenyl compounds, e.g. Tinopal® CBS-X, di-amino stilbene di-sulfonic acid compounds, e.g. Tinopal® DMS pure Xtra and Blankophor® HRH, and Pyrazoline compounds, e.g. Blankophor® SN, and coumarin compounds, e.g. Tinopal® SWN.

The content of optical brightener is usually in a range of 0.05% to 2% by weight, preferably 0.1% to 1.5%, more preferably 0.2% to 1.0% by weight, based on the total weight of the composition.

### Defoamers/Foam Inhibitors/Suds Suppressors

Useful foam inhibitors (also denoted as defoamers or suds suppressors) include, for example, silicone oils, alkyl phosphate esters, soaps, paraffins or combinations thereof.

The laundry detergent composition according to the invention preferably comprises from 0 to 10% by weight, more preferably from 0 to 5% by weight, in particular from 0 to 1.5% by weight, based on the total weight of the composition, of at least one defoamer. If the laundry detergent composition comprises at least one defoamer, then the amount is at least 0.0001% by weight, more preferably at least 0.001% by weight, in particular at least 0.01% by weight, based on the total weight of the composition.

### Antimicrobial Agents

In one embodiment, the laundry detergent composition can comprise at least one antimicrobial (sanitizing) agent. Suitable antimicrobial agents are in particular quaternary ammonium compounds. Quaternary ammonium compounds and their use in rinse aid formulations are described in US2022386598. Preferably, the antimicrobial quaternary ammonium compound is selected from C₁₂-C₁₆ alkyl dimethyl benzyl ammonium chloride, didecyl dimethyl ammonium chloride, dioctyl dimethyl ammonium chloride, octyl decyl dimethyl ammonium chloride, or a combination thereof. Further examples of quaternary ammonium compounds are benzethonium chloride, ethylbenzyl alkonium chloride, myristyl trimethyl ammonium chloride, methyl benzethonium chloride, cetalkonium chloride, cetrimonium bromide (CTAB), camitine, dofanium chloride, tetraethyl ammonium bromide (TEAB), domiphen bromide, benzododecinium bromide, benzoxonium chloride, choline, cocamidopropyl betaine (CAPB), denatonium, and mixtures thereof. Said antimicrobial agents provide a broad-spectrum activity against wide range of different types of microorganisms (including both aerobic and anaerobic microorganisms, gram positive and gram negative microorganisms), including bacteria, yeasts, molds, fungi, algae, and other problematic microorganisms.

### Organic Solvent (Component h))

Suitable organic solvents are selected from mono- or polyhydric alcohols, alkanolamines and glycol ethers. The solvents are preferably selected from ethanol, n-propanol, isopropanol, n-butanol, iso-butanol, n-pentanol, iso-pentanol, n-hexanol, iso-hexanol, glycol, propanediol, butanediol, glycerol, diglycol, propyl diglycol, butyl diglycol, hexylene glycol, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl ether, propylene glycol ethyl ether, propylene glycol propyl ether, dipropylene glycol monomethyl ether, dipropylene glycol monoethyl ether, diisopropylene glycol monomethyl ether, diisopropylene glycol monoethyl ether, methoxytriglycol, ethoxytriglycol, butoxytriglycol, butoxyethoxy-2-propanol, 3-methyl-3-methoxybutanol, propylene glycol t-butyl ether and mixtures of these solvents. In a preferred embodiment the organic solvent is selected from ethanol, n-propanol, isopropanol, n-butanol, glycerol, ethylene glycol, diethylene glycol, propylene glycol, polyethylene glycols, 1,3-butanediol, 1,4-butanediol, dipropylene glycol and mixtures thereof.

In one embodiment, the laundry detergent composition according to the invention is a liquid formulation. Liquid laundry detergents generally comprise water as solvent. In addition, liquid laundry detergent compositions may comprise at least one organic solvent that is fully or at least partly water miscible. Preferably, the liquid laundry detergent composition comprises at least one organic solvent in an amount from 0 to 10% by weight, more preferably from 0 to 5% by weight, based on the total weight of the composition.

In one embodiment, the laundry detergent composition according to the invention is a unit dose article. Unit dose article in general contain at least one organic solvent instead of or in addition to water. In a special embodiment, unit dose articles contain at least one organic solvent and no added water at all. Preferably, laundry detergent composition unit dose articles comprise at least one organic solvents in an amount from 5 to 40% by weight, preferably from 7.5 to 35% by weight, in particular from 10 to 30% by weight, based on the total weight of the composition.

### Water (Component i))

The laundry detergent composition may comprise water or may be free of added water.

In one embodiment, the laundry detergent composition according to the invention is a liquid formulation. Liquid laundry detergents preferably comprise water in an amount from 20 to 90% by weight, more preferably from 40 to 80% by weight, based on the total weight of the composition.

In another embodiment, the laundry detergent composition according to the invention is a unit dose article. As mentioned above, unit dose articles contain no added water or only a limited amount of water to ensure that the water-soluble polymer remains stable before the pack is used for washing. Preferably, laundry detergent compositions in form of a unit dose article contain water in an amount of at the most 10% by weight, more preferably at the most 5% by weight, in particular at the most 1% by weight, especially at the most 0.5% by weight, based on the total weight of the composition. In a special embodiment, unit dose articles contain no added water at all.

A special embodiment is a laundry detergent composition in liquid form, comprising:
a) 0.0005 to 2.5% by weight, based on the total weight of the composition, of at least one structural polypeptide,
b1) 10 to 50% by weight, based on the total weight of the composition, of at least one anionic surfactant,
b2) 3.0 to 15% by weight, based on the total weight of the composition, of at least one nonionic surfactant,
c) 1.0 to 15% by weight, based on the total weight of the composition, of at least one builder,
d) 0 to 8% by weight (preferably from 0.005 to 8% by weight, in particular from 0.01 to 5% by weight) of at least one enzyme, based on the proportion of enzyme protein in the total weight of the composition,
e) 0 to 20% by weight (preferably from 0.1 to 15% by weight, in particular from 0.5 to 10% by weight), based on the total weight of the composition, of at least one polymeric antiredeposition agent,
f) 0 to 20% by weight (preferably at least from 0.5% by weight, more preferably at least 1% by weight), based on the total weight of the composition, of at least one bleach,
g) 0 to 80% by weight (preferably at least 0.01% by weight, more preferably at least 0.1% by weight), based on the total weight of the composition, of at least one further additive different from components a) to f), preferably selected from surfactants different from anionic and nonionic surfactants, rheology modifier, pH controlling agents, corrosion inhibitors, defoamers, dyes, fragrances, fillers, tableting aids, disintegrants, solubilizers, electrolytes, optical brighteners, hydrotropes, antimicrobial ingredients, antioxidants and mixtures thereof, and
h) 0% to 10% by weight (preferably 5% to 10% by weight), based on the total weight of the composition, of at least one organic solvent,
i) 20% to 90% by weight, based on the total weight of the composition, of water.

The composition may be in the form of a concentrate having a reduced water content, preferably in the range of from 10 to 40% by weight.

A further special embodiment is a laundry detergent composition in form of a (completely) liquid unit dose article with a water-soluble packaging or coating, comprising:
a) 0.0005 to 2.5% by weight, based on the total weight of the composition, of at least one structural polypeptide,
b1) 10 to 50% by weight, based on the total weight of the composition, of at least one anionic surfactant,
b2) 3 to 25% by weight, based on the total weight of the composition, of at least one nonionic surfactant,
c) 0.5 to 10.0% by weight, based on the total weight of the composition, of at least one builder,
d) 0% to 8% by weight (preferably from 0.005 to 8% by weight, in particular from 0.01 to 5% by weight) of at least one enzyme, based on the proportion of enzyme protein in the total weight of the composition,
e) 0% to 5.0% by weight (preferably from 0.1 to 5.0% by weight), based on the total weight of the composition, of at least one polymeric antiredeposition agent,
g) 0% to 80% by weight (preferably at least 0.01% by weight, more preferably at least 0.1% by weight), based on the total weight of the composition, of at least one further additive different from components a) to f), preferably selected from surfactants different from anionic and nonionic surfactants, rheology modifier, pH controlling agents, corrosion inhibitors, defoamers, dyes, fragrances, fillers, tableting aids, disintegrants, solubilizers, electrolytes, optical brighteners, hydrotropes, antimicrobial ingredients, antioxidants and mixtures thereof, and
h) 5% to 40% by weight, based on the total weight of the composition, of at least one organic solvent,
i) at the most 5% by weight, in particular at the most 1% by weight, especially at the most 0.5% by weight, based on the total weight of the composition of water.

A further special embodiment is a laundry detergent composition in form of a (completely) solid unit dose article with a water-soluble packaging or coating, comprising:
a) 0.0005 to 2.5% by weight, based on the total weight of the composition, of at least one structural polypeptide,
b1) 10 to 50% by weight, based on the total weight of the composition, of at least one anionic surfactant,
b2) 3 to 15% by weight, based on the total weight of the composition, of at least one nonionic surfactant,
c) 1% to 80% by weight, based on the total weight of the composition, of at least one builder, preferably comprising at least one aluminosilicate and optionally at least one further builder,
d) 0% to 8% by weight (preferably from 0.005 to 8% by weight, in particular from 0.01 to 5% by weight) of at least one enzyme, based on the proportion of enzyme protein in the total weight of the composition,
e) 0% to 5% by weight (preferably from 0.1 to 5.0% by weight), based on the total weight of the composition, of at least one polymeric antiredeposition agent,
f) 0% to 30% by weight (preferably at least from 0.5% by weight, more preferably at least 1% by weight), based on the total weight of the composition, of at least one bleach,
g) 0% to 80% by weight (preferably at least 0.01% by weight, more preferably at least 0.1% by weight), based on the total weight of the composition, of at least one further additive different from components a) to f), preferably selected from surfactants different from anionic and nonionic surfactants, rheology modifier, pH controlling agents, corrosion inhibitors, defoamers, dyes, fragrances, fillers, tableting aids, disintegrants, solubilizers, electrolytes, optical brighteners, hydrotropes, antimicrobial ingredients, antioxidants and mixtures thereof,
h) at the most 5% by weight, based on the total weight of the composition, of at least one organic solvent,
i) at the most 5% by weight, based on the total weight of the composition of water.

The laundry detergent composition in form of a solid unit dose article preferably comprises at least one builder, more preferably at least one aluminosilcate, in particular at least one zeolite, in an amount from 5 to 80% by weight, more preferably from 10 to 65% by weight, in particular from 15 to 50% by weight, based on the total weight of the composition.

The laundry detergent composition in form of a solid unit dose article preferably has a water content of less than 5% by weight, more preferably less than 1% by weight, in particular less than 0.1% by weight, based on the total weight of the composition.

The laundry detergent composition in form of a solid unit dose article preferably has a content of organic solvents of less than 5% by weight, more preferably less than 3% by weight, in particular less than 1% by weight, based on the total weight of the composition.

The examples given above are intended to illustrate the formulation possibilities of the laundry detergents according to the invention without limiting them. Thus, e.g. the laundry detergent composition according to the invention can be liquid unit dose article or in form of a completely solid unit dose article, but forms that contain liquid and solid components are also possible.

In all aspects/embodiments described above, the structural polypeptide, specifically the silk polypeptide, is preferably present in gel, particularly hydrogel, form in the laundry detergent composition.

Various modifications and variations of the invention will be apparent to those skilled in the art without departing from the scope of invention. Although the invention has been described in connection with specific preferred embodiments, it should be understood that the invention as claimed should not be unduly limited to such specific embodiments. Indeed, various modifications of the described modes for carrying out the invention which are obvious to those skilled in the art in the relevant fields are intended to be covered by the present invention.

### PREFERRED EMBODIMENTS OF THE INVENTION

1. A laundry detergent composition, comprising:
a) a structural polypeptide, and
b) at least one surfactant.
   2. The laundry detergent composition according to embodiment 1, wherein the structural polypeptide a) is a silk polypeptide.
   3. The laundry detergent composition according to embodiment 2, wherein the silk polypeptide is a recombinant or synthetic silk polypeptide, preferably a spider silk polypeptide.
   4. The laundry detergent composition according to embodiment 2 or 3, wherein the silk polypeptide
comprises or consists of a protein chain that does not have at least two units of the same sequence motifs (a single unit of amino acids), or
comprises or consists of at least two identical repetitive units.
   5. The laundry detergent composition according to any of embodiments 2 to 4, wherein the silk polypeptide is free of non-repetitive units.
   6. The laundry detergent composition according to embodiment 4 or 5, wherein the single unit or the repetitive units are independently selected from the group consisting of
module C having an amino acid sequence according to SEQ ID NO: 1 or variants thereof,
module C^{Cys} having an amino acid sequence according to SEQ ID NO: 2 or variants thereof,
module C^{Lys} having an amino acid sequence according to SEQ ID NO: 3 or variants thereof.
   7. The laundry detergent composition according to any of embodiments 2 to 6, wherein the silk polypeptide is selected from the group consisting of (C)ₘ, (C)ₘC^{Cys}, (C)ₘC^{Lys}, C^{Cys}(C)ₘ, C^{Lys}(C)ₘ, (C^{Cys})ₘ and (C^{Lys})ₘ, wherein m is an integer of 1 to 96.
   8. The laundry detergent composition according to embodiment 7, wherein the silk polypeptide is selected from the group consisting of C₁, C₂, C₃, C₄, C₅, C₆, C₇, C₈, C₁₆, C₃₂, C₄₈, (C)₁C^{Cys}, (C)₂C^{Cys}, (C)₃C^{Cys}, (C)₄C^{Cys}, (C)₅C^{Cys}, (C)₆C^{Cys} (C)₇C^{Cys}, (C)₈C^{Cys} (C)₁₆C^{Cys}, (C)₃₂C^{Cys}, (C)₄₈C^{Cys}, (C)₁C^{Lys}, (C)₂C^{Lys}, (C)₃C^{Lys} (C)₄C^{Lys} (C)₅C^{Lys} (C)₆C^{Lys}, (C)₇C^{Lys}, (C)₈C^{Lys}, (C)₁₆C^{Lys}, (C)₃₂C^{Lys}, (C)₄₈C^{Lys} C^{Cys}(C)₁, C^{Cys}(C)₂, C^{Cys}(C)₃, C^{Cys}(C)₄, C^{Cys}(C)₅, C^{Cys}(C)₆, C^{Cys}(C)₇, C^{Cys}(C)₈, C^{Cys}(C)₁₆, C^{Cys}(C)₃₂, C^{Cys}(C)₄₈, C^{Lys}(C)₁, C^{Lys}(C)₂, C^{Lys}(C)₃, C^{Lys}(C)₄, C^{Lys}(C)₅, C^{Lys}(C)₆, C^{Lys}(C)₇, C^{Lys}(C)₈, C^{Lys}(C)₁₆, C^{Lys}(C)₃₂, C^{Lys}(C)₄₈, C^{Cys}₁, C^{Cys}₂, C^{Cys}₃, C^{Cys}₄, C^{Cys}₅, C^{Cys}₆, C^{Cys}₇, C^{Cys}₈, C^{Cys}₁₆, C^{Cys}₃₂, C^{Cys}₄₈, C^{Lys}₁, C^{Lys}₂, C^{Lys}₃, C^{Lys}₄, C^{Lys}₅, C^{Lys}₆, C^{Lys}₇, C^{Lys}₈, C^{Lys}₁₆, C^{Lys}₃₂ and C^{Lys}₄₈.
   9. The laundry detergent composition according to any of the preceding embodiments, comprising from 0.0005 to 2.5% by weight, preferably from 0.001 to 2.0% by weight, in particular from 0.005 to 1.5% by weight, based on the total weight of the composition, of at least one structural polypeptide (component a)).
   10. The laundry detergent composition according to any of the preceding embodiments, comprising
b1) at least one anionic surfactant, and
b2) optionally at least one nonionic surfactant.
   11. The laundry detergent composition according to any of the preceding embodiments, comprising from 3 to 60% by weight, preferably from 5 to 50% by weight, in particular from 7 to 45% by weight, based on the total weight of the composition, of at least one anionic surfactant b1).
   12. The laundry detergent composition according to any of the preceding embodiments, comprising from 0 to 40% by weight, preferably from 1 to 30% by weight, in particular from 2.5 to 25% by weight, based on the total weight of the composition, of at least one nonionic surfactant b2).
   13. The laundry detergent composition according to any of the preceding embodiments, comprising at least one builder (component c)).
   14. The laundry detergent composition according to any of the preceding embodiments, comprising at least 0.1% by weight, preferably at least 0.5% by weight, in particular at least 1% by weight, based on the total weight of the composition, of at least one builder (component c)).
   15. The laundry detergent composition according to any of the preceding embodiments, comprising at least one enzyme (component d)).
   16. The laundry detergent composition according to any of the preceding embodiments, comprising at least one enzyme d) in an amount of at least 0.001% by weight, preferably at least 0.01% by weight, in particular at least 0.05% by weight, enzyme protein based on the total weight of the composition.
   17. The laundry detergent composition according to any of the preceding embodiments, comprising at least one polymeric antiredeposition agent (component e)).
   18. The laundry detergent composition according to any of the preceding embodiments, comprising from 0 to 20% by weight, preferably from 0.1 to 15% by weight, in particular from 0.5 to 10% by weight, based on the total weight of the composition, of at least one polymeric antiredeposition agent (component e)).
   19. The laundry detergent composition according to any of the preceding embodiments, comprising at least one bleach (component f)).
   20. The laundry detergent composition according to any of the preceding embodiments, comprising from 0 to 30% by weight, preferably from 0.1 to 25% by weight, based on the total weight of the composition, of at least one bleach f).
   21. The laundry detergent composition according to any of the preceding embodiments, comprising at least one at least one additive different from components a) to f) (component g)), preferably selected from surfactants different from anionic and nonionic surfactants, rheology modifiers, pH controlling compounds, corrosion inhibitors, defoamers, dyes, fragrances, fillers, tableting aids, disintegrants, solubilizers, electrolytes, optical brighteners, hydrotropes, antimicrobial ingredients, antioxidants and mixtures thereof.
   22. The laundry detergent composition according to any of the preceding embodiments, comprising at least one organic solvent (component h)).
   23. The laundry detergent composition according to any of the preceding embodiments, comprising water (component i)).
   24. The laundry detergent composition according to any of embodiments 1 to 23 in liquid form, comprising:
a) 0.0005 to 2.5% by weight, based on the total weight of the composition, of at least one structural polypeptide,
b1) 10 to 50% by weight, based on the total weight of the composition, of at least one anionic surfactant,
b2) 3.0 to 15% by weight, based on the total weight of the composition, of at least one nonionic surfactant,
c) 1.0% to 15% by weight, based on the total weight of the composition, of at least one builder,
d) 0% to 8% by weight (preferably from 0.005 to 8% by weight, in particular from 0.01 to 5% by weight) of at least one enzyme, based on the proportion of enzyme protein in the total weight of the composition,
e) 0% to 20% by weight (preferably from 0.1 to 15% by weight, in particular from 0.5 to 10% by weight), based on the total weight of the composition, of at least one polymeric antiredeposition agent,
f) 0% to 20% by weight (preferably at least from 0.5% by weight, more preferably at least 1% by weight), based on the total weight of the composition, of at least one bleach,
g) 0% to 80% by weight (preferably at least 0.01% by weight, more preferably at least 0.1% by weight), based on the total weight of the composition, of at least one further additive different from components a) to f), preferably selected from surfactants different from anionic and nonionic surfactants, rheology modifier, pH controlling agents, corrosion inhibitors, defoamers, dyes, fragrances, fillers, tableting aids, disintegrants, solubilizers, electrolytes, optical brighteners, hydrotropes, antimicrobial ingredients, antioxidants and mixtures thereof, and
h) 0% to 10% by weight (preferably 5% to 10% by weight), based on the total weight of the composition, of at least one organic solvent,
i) 20% to 90% by weight, based on the total weight of the composition, of water.
   25. The laundry detergent composition according to any of embodiments 1 to 23 in form of a liquid unit dose article with a water-soluble packaging or coating, comprising:
a) 0.0005 to 2.5% by weight, based on the total weight of the composition, of at least one structural polypeptide,
b1) 10 to 50% by weight, based on the total weight of the composition, of at least one anionic surfactant,
b2) 3 to 25% by weight, based on the total weight of the composition, of at least one nonionic surfactant,
c) 0.5 to 10.0% by weight, based on the total weight of the composition, of at least one builder,
d) 0% to 8% by weight (preferably from 0.005 to 8% by weight, in particular from 0.01 to 5% by weight) of at least one enzyme, based on the proportion of enzyme protein in the total weight of the composition,
e) 0% to 5.0% by weight (preferably from 0.1 to 5.0% by weight), based on the total weight of the composition, of at least one polymeric antiredeposition agent,
g) 0% to 80% by weight (preferably at least 0.01% by weight, more preferably at least 0.1% by weight), based on the total weight of the composition, of at least one further additive different from components a) to f), preferably selected from surfactants different from anionic and nonionic surfactants, rheology modifier, pH modifying agents, corrosion inhibitors, defoamers, dyes, fragrances, fillers, tableting aids, disintegrants, solubilizers, electrolytes, optical brighteners, hydrotropes, antiredeposition agents, antimicrobial ingredients, antioxidants and mixtures thereof, and
h) 5% to 40% by weight, based on the total weight of the composition, of at least one organic solvent,
i) at the most 5% by weight, in particular at the most 1% by weight, especially at the most 0.5% by weight, based on the total weight of the composition of water.
   26. The laundry detergent composition according to any of embodiments 1 to 23 in form of a solid unit dose article with a water-soluble packaging or coating, comprising:
a) 0.0005 to 2.5% by weight, based on the total weight of the composition, of at least one structural polypeptide,
b1) 10 to 50% by weight, based on the total weight of the composition, of at least one anionic surfactant,
b2) 3 to 15% by weight, based on the total weight of the composition, of at least one nonionic surfactant,
c) 1% to 80% by weight, based on the total weight of the composition, of at least one builder, preferably comprising at least one aluminosilicate and optionally at least one further builder,
d) 0% to 8% by weight (preferably from 0.005 to 8% by weight, in particular from 0.01 to 5% by weight) of at least one enzyme, based on the proportion of enzyme protein in the total weight of the composition,
e) 0% to 5.0% by weight (preferably from 0.1 to 5.0% by weight), based on the total weight of the composition, of at least one polymeric antiredeposition agent,
f) 0% to 30% by weight (preferably at least from 0.5% by weight, more preferably at least 1% by weight), based on the total weight of the composition, of at least one bleach,
g1) 0% to 80% by weight (preferably at least 0.01% by weight, more preferably at least 0.1% by weight), based on the total weight of the composition, of at least one further additive different from components a) to f), preferably selected from surfactants different from anionic and nonionic surfactants, rheology modifier, pH modifying agents, corrosion inhibitors, defoamers, dyes, fragrances, fillers, tableting aids, disintegrants, solubilizers, electrolytes, optical brighteners, hydrotropes, antiredeposition agents, antimicrobial ingredients, antioxidants and mixtures thereof, and
h) at the most 5% by weight, based on the total weight of the composition, of at least one organic solvent,
i) at the most 5% by weight, based on the total weight of the composition of water.
   27. The laundry detergent composition according to any of the preceding embodiments, wherein the laundry detergent composition is in liquid form or in gel form or the laundry detergent composition is a multicompartment formulation, wherein the multicompartment formulation preferably contains the structural polypeptide in gel form.
   28. A method for cleaning laundry in a washing machine, in which the laundry to be cleaned is contacted with a laundry detergent composition as defined in any embodiments 1 to 27.
   29. The use of a structural polypeptide as defined as in any of embodiments 2 to 8, especially of a silk polypeptide, in a laundry detergent composition.
   30. The use according to embodiment 29, wherein the structural polypeptide is defined as in any of embodiments 2 to 8.
   31. The use according to embodiment 29 or 30 for
improving or maintaining the properties of textiles, in particular improving or maintaining at least one property selected from
i) the mechanical properties and/or usage properties of textiles,
ii) the optics of textiles,
iii) the haptic of textiles and/or
iv) the odour properties of textiles,
extending the life of textiles,
reduction of the amount of microfibres released during washing,
enabling to dispense the use of additional laundry care products.
   32. The use of a laundry detergent composition as defined in any of embodiments 1 to 27, in the treatment of laundry in a washing machine for
improving or maintaining the properties of textiles, in particular improving or maintaining at least one property selected from
i) the mechanical properties and/or usage properties of textiles,
ii) the optics of textiles,
iii) the haptic of textiles and/or
iv) the odour properties of textiles,
extending the life of textiles,
reduction of the amount of microfibres released during washing,
enabling to dispense the use of additional laundry care products.

### FIGURE LEGEND

The following figures are merely illustrative of the present invention and should not be construed to limit the scope of the invention as indicated by the appended claims in any way.

FIG. 1: Shows a scanning electron microscope (SEM) image of surface structure of a new untreated textile (65% polyester (PES)/35% cotton (CO)) sample (A: 200× magnification; B: 500× magnification; C: 1000× magnification) Used abbreviations following DIN EN ISO 2076:2014-03 (chemical fibers) and DIN 60001-1:2001-05 (natural fibers).

FIG. 2: Shows a scanning electron microscope (SEM) image of surface structure of a textile (65% PES/35% CO) sample treated with Ecolabel LLD laundry detergent (A: 200× magnification; B: 500× magnification; C: 1000× magnification). The treatment with detergent alone (this FIGURE) shows a strong strain on the textile sample compared to untreated textile sample (see FIG. 1).

FIG. 3: Shows a scanning electron microscope (SEM) image of surface structure of a textile (65% PES/35% CO) sample treated with Ecolabel LLD laundry detergent and silk gel (A: 200× magnification; B: 500× magnification; C: 1000× magnification) The treatment with detergent alone (see FIG. 2) shows a very high strain on the textile sample compared to untreated textile sample (see FIG. 1). The comparison of the textile treated with detergent and silk gel (this FIGURE) shows a very low strain and therefore significantly higher material protection than that of a textile treated with detergent (see FIG. 2).

### EXAMPLES

The following examples are illustrative of the automatic dishwashing compositions of the invention. They are not intended to limit the invention described above in any way.

### Example 1

### I) Laundry Detergent Formulations

A laundry detergent composition was prepared from the following components:

### Liquid Laundry Detergent

| | percentage total |
|---|---|
| | composition |
| Anionic surfactants | 20% |
| Nonionic surfactants | 7% |
| Builders | 5% |
| Antiredeposition polymers | 3% |
| Enzymes | 0.1% |
| Perfume | 0.5% |
| Structural protein gel containing 3 wt. % silk | 3% |
| protein^{a)} | |
| Further additives | 2% |
| water | 59.4 |

^{a)}i.e. a total content of 0.09% silk protein in the composition

### Comparative Example: Without Structural Protein

According to the invention: with structural protein gel containing 3 wt. % silk protein. Laundry detergent compositions in form of a unit dose (laundry caps/pods/pouches) can be obtained from the same chemical composition but replacing (almost) the complete amount of water by an organic solvent, like glycols or glycerol.

### II) Application Examples

### 1.) Conditions of Washing Tests

The washing tests were conducted in a Bosch Washing Machine (Bosch Waschmaschine Serie 6 WAG28400, 8 kg, 1400 U/min) with the cycle “Jeans/Dunkle Wasche” with a load of 3.5 kg.

The following standard fabric swatches (20 cm×20 cm) from normal textiles used for garment production were employed: 100% blue cotton (150 g/m²), 100% blue polyester (PES, 150 g/m²), 100% blue polyamide (PA, 150 g/m²). For the tests, the samples were washed 10 times with 35 ml laundry detergent without silk protein (comparison) and with silk protein (according to the invention).

### 2.) Textile Property Tests

### Mechanical Properties

The fabrics were analyzed via tensile testing machine (Zwick BT1-FK0.5N.D14 from Zwick/Roell GmbH & Co. KG) to determine the tear strength according to EN Iso 13937. The tear strength is defined as the force required to start or to continue to tear a fabric. The mean tear force was determined as an average of 10 measurements of each test sample. The tear force is qualified as “across warp” or “across weft”, according to whether the tear is made across the warp (warp threads are torn) or weft threads (weft threads are torn) respectively.

### Determination of Tear Force

| Test | Laundry | | Laundry washed with | | Laundry washed with | |
|---|---|---|---|---|---|---|
| Material | untreated | | detergent without | | detergent with silk | |
| 100% | (comparison) | | silk polypeptide | | polypeptide (according | |
| cotton | Warp | Weft | (comparison) | | to the invention) | |
| (150 g/m²) | [N] | [N] | Warp N | Weft N | Warp N | Weft N |
| | 26.1 | 23.7 | 11.1 | 13.5 | 19.9 | 18.3 |

| | | | Laundry washed with | | Laundry washed with | |
|---|---|---|---|---|---|---|
| | Laundry | | detergent without | | detergent with silk | |
| Test | untreated | | silk polypeptide | | polypeptide (according | |
| Material | (comparison) | | (comparison) | | to the invention) | |
| 100% PES | Warp | Weft | Warp | Weft | Warp | Weft |
| (150 g/m²) | [N] | [N] | [N] | [N] | [N] | [N] |
| | 46.2 | 43.5 | 30.3 | 31.5 | 39.8 | 38.5 |

| | | | Laundry washed with | | Laundry washed with | |
|---|---|---|---|---|---|---|
| | Laundry | | detergent without | | detergent with silk | |
| Test | untreated | | silk polypeptide | | polypeptide (according | |
| Material | (comparison) | | (comparison) | | to the invention) | |
| 100% PA | Warp | Weft | Warp | Weft | Warp | Weft |
| (150 g/m²) | [N] | [N] | [N] | [N] | [N] | [N] |
| | 36.5 | 31.8 | 19.7 | 18.2 | 25.5 | 26.9 |

The result is a clear improvement in the tear strength after the washing process for the swatches washed in presence of silk polypeptide in comparison with the samples washed with the same detergent composition without silk polypeptide.

### Color Testing

Instrumental assessment of change in color for determination of grey scale rating according to DIN EN ISO 105-A05:1997.

| | | | Laundry washed with | | Laundry washed with | |
|---|---|---|---|---|---|---|
| | | | detergent without | | detergent with silk | |
| Test | | | silk polypeptide | | polypeptide (according | |
| Material | Laundry | | (comparison) | | to the invention) | |
| 100% | untreated | | | GS color | | GS color |
| cotton | (comparison) | | | change vs | | change vs |
| (150 g/m²) | — | — | ΔE | reference | ΔE | reference |

| | | | |
|---|---|---|---|
| 2.77 | 3/4 | 1.15 | 4/5 |

| | | | Laundry washed with | | Laundry washed with | |
|---|---|---|---|---|---|---|
| | | | detergent without | | detergent with silk | |
| | | | silk polypeptide | | polypeptide (according | |
| Test | Laundry | | (comparison) | | to the invention) | |
| Material | untreated | | | GS color | | GS color |
| 100% PES | (comparison) | | | change vs | | change vs |
| (150 g/m²) | — | — | ΔE | reference | ΔE | reference |

| | | | |
|---|---|---|---|
| 2.61 | 3/4 | 0.85 | 4/5 |

| | | | Laundry washed with | | Laundry washed with | |
|---|---|---|---|---|---|---|
| | | | detergent without | | detergent with silk | |
| | | | silk polypeptide | | polypeptide (according | |
| Test | Laundry | | (comparison) | | to the invention) | |
| Material | untreated | | | GS color | | GS color |
| 100% PA | (comparison) | | | change vs | | change vs |
| (150 g/m²) | — | — | ΔE | Reference | ΔE | Reference |

| | | | |
|---|---|---|---|
| 2.44 | 3/4 | 0.78 | 4/5 |

The result is a clear improvement in the reduction of color fading after the washing process for the swatches washed in presence of silk polypeptide in comparison with the samples washed with the same detergent composition without silk polypeptide. The reduced abrasion of the fibers during the wash, will generate less damage on the fibers and therefore less fibrillation, leaving the colors more vivid due to less surface light scattering.

### Softness

A panel test was performed with 10 normal consumers of laundry detergents (i.e. with no special expertise in this field). The question to be answered was “do you perceive any difference in softness between the two samples”. The consumers had one hand on an untreated reference sample and the other on a test sample, identified by a number. The test was performed blind, i.e. the consumers did not which fabric was the reference and which the sample to be evaluated. The consumer were asked to give a rating of “softness” between 0=not soft and 5=very soft. The result is the average of the evaluation of 10 consumers for each material.

| | | Laundry washed with |
|---|---|---|
| | Laundry washed with | detergent with silk |
| | detergent without | polypeptide |
| Test | silk polypeptide | (according to the |
| Material | (comparison) | invention) |
| 100% cotton | 2.1 | 3.8 |
| (150 g/m²) | | |

| | | Laundry washed with |
|---|---|---|
| | Laundry washed with | detergent with silk |
| | detergent without | polypeptide |
| Test | silk polypeptide | (according to the |
| Material | (comparison) | invention) |
| 100% PES | 3.5 | 3.9 |
| (150 g/m²) | | |

| | | Laundry washed with |
|---|---|---|
| | Laundry washed with | detergent with silk |
| | detergent without | polypeptide |
| Test | silk polypeptide | (according to the |
| Material | (comparison) | invention) |
| 100% PA | 3.7 | 4.1 |
| (150 g/m²) | | |

The result is a clear perceived improvement in the softness after the washing process for the swatches washed in presence of Silk polypeptide in comparison with the samples washed with the same detergent composition without Silk polypeptide.

### Microfiber Loss Test:

The test was performed in a 1000 mL beaker, by dosing the same proportional amount of detergent composition which normally is used in a main wash in a 10 liter laundry machine (3.5 mL). In each experiment 5 swatches (each of 6 g) have been used, in order to increase friction and when possible release enough microfibers so that they can be quantitatively recorded and statistically evaluated. The total weight of fabric in the experiment was 5×6 g per swatch=30 g of PES textile fibers. In the comparative experiment, the detergent did not contain silk polypeptide, whereas in the experiment according to the invention, Silk polypeptide was contained. A further experiment has been performed in normal tap water (laundry untreated), instead of a detergent composition to verify the amount of microfibers lost by the textile by itself. The tests were performed with PES, by far the most present synthetic fiber in the consumption of consumers garments. The temperature was raised and kept for 1 hour at 40° C. and the swatches were agitated continuously by means of a mechanical stirrer with medium agitation (30 rpm—with stop and go alternative cycles every 2 min). After the treatment the swatches were taken out of the liquor and the liquor filtered with a paper filter (Ahlstrom Filter Paper Grade 5, 2.5 cm) under light vacuum. The filters were dried overnight at 80° C. under light vacuum. The difference in weight between the paper filter before the filtration of the laundry liquor and afterwards were recorded. The experiment was repeated 3 times for each of the comparison examples and the example according to the invention.

| | | Laundry washed | Laundry washed with |
|---|---|---|---|
| | | with detergent | detergent with |
| | Laundry | without | silk polypeptide |
| Test | untreated | silk polypeptide | (according to the |
| Material | (comparison) | (comparison) | invention) |
| 100% PES | 60 mg of | 113 mg of | 49 mg of |
| (150 g/m²) | released fibers | released fibers | released fibers |

The result shows a clear improvement in the avoidance of release of microfibers of the tested polyester textile material in presence of silk polypeptide in comparison with the samples washed with the same detergent composition without silk polypeptide, and even in comparison with the original untreated material. This might be explained by the protecting action of the silk polypeptide coating on the fibers.

### Conclusion:

A modern laundry liquid detergent composition (also in a form of unit dose article, like sachets/caps/pods) containing silk polypeptide at a concentration in the ppm range can improve the mechanical tear force, color, softness and also the release of microfibers due to mechanical shedding.

### Example 2

Test execution follows the test procedure for comparative detergent and detergent additive tests (SOP-QM 11 203 050A:2023-05; Hohenstein Laboratories GmbH & Co. KG).

### Materials & Methods

Test textiles: new and pre-pilled coloured textiles
Washing machine: Miele Softtronic W 1935 WPS WTL
Washing program: cotton, short
Washing temperature: 40° C.
Load weight: 3 kg
Water hardness: (14±1,5°) dH ((2,5±0,3) mmol/l)
Drying procedure: tumble drying and/or line drying

### Results

### 1) Colour Maintenance:

Measurements with regard to colour maintenance were performed with a colour measurement device. Colour differences were calculated from brightness, hue and croma according to DIN 6174:2007-10. Differences in colour were determined. The test was conducted with a new untreated textile. 3 Test samples (No. 1 to 3) from the new untreated textile were used. The lower the measured value, the lower the colour difference.

The results of the colorimetric assessment of colour maintenance are shown in the Table below:

| No. | A | B |
|---|---|---|
| 1 | 12.5 | 11.9 |
| 2 | 14.1 | 14.0 |
| 3 | 17.8 | 16.1 |

Test Textile Washed/Treated with:
A: laundry detergent composition without silk (− silk)
B: laundry detergent composition with silk (+ silk)

Laundry detergent composition without silk (− silk): Ecolabel LLD with a dosage of 35.8 g. Laundry detergent composition with silk (+ silk): Ecolabel LLD with a dosage of 35.8 g+spider silk hydrogel (18.5 g) in 100 g water.

The experimental results show that the colour maintenance was better with test textiles washed/treated with a composition comprising silk (+ silk).

### 2) Surface Maintenance:

The change in surface attractivity was assessed on new untreated textiles visually by a panel according to grades (1=high surface attractivity, 5=low surface attractivity) and ranking. The best product was graded as rank 1. 2 Test samples (No. 1 to 3) from the new untreated textile were used. The number of wash cycles was 20.

The results of the surface attractivity test are shown in the Table below:

| No. | Number of wash cycles | Start rank | A | B |
|---|---|---|---|---|
| 1 | 20 | 1 | 3 | 2 |
| 2 | 20 | 1 | 3 | 2 |
| 3 | 10 | 1 | 3 | 2 |

Test Textile Washed/Treated with:
A: laundry detergent composition without silk (− silk)
B: laundry detergent composition with silk (+ silk)

Laundry detergent composition without silk (− silk): Ecolabel LLD with a dosage of 35.8 g. Laundry detergent composition with silk (+ silk): Ecolabel LLD with a dosage of 35.8 g+spider silk hydrogel (18.5 g) in 100 g water.

The experimental results show that the surface attractivity was better with test textiles washed/treated with a composition comprising silk (+ silk).

The change in surface attractivity was further assessed on pre-pilled textiles visually by a panel according to grades (1=high surface attractivity, 5=low surface attractivity) and ranking. The best product was graded as rank 1. 2 Test samples (No. 1 to 2) from pre-pilled textiles were used. The number of wash cycles was in one case 10 and in the other case 20.

The results of the surface attractivity test are shown in the Table below:

| No. | Number of wash cycles | Start rank | A | B |
|---|---|---|---|---|
| 1 | 10 | 2 | 2 | 1 |
| 2 | 20 | 4 | 3 | 1 |

Test Textile Washed/Treated with:
A: laundry detergent composition without silk (− silk)
B: laundry detergent composition with silk (+ silk)

Laundry detergent composition without silk (− silk): Ecolabel LLD with a dosage of 35.8 g. Laundry detergent composition with silk (+ silk): Ecolabel LLD with a dosage of 35.8 g+spider silk hydrogel (18.5 g) in 100 g water.

The experimental results show that the surface attractivity of pre-pilled textiles washed/treated with a composition with silk (+ silk) could be improved.

### 3) Softness/Soft Hand:

Softness/soft hand was assessed by 5 experts experienced in sensorial evaluation of washing tests (SOP-QM 11 2 02 020:2023-02; Hohenstein Laboratories
GmbH & Co. KG).). Changes in softness were assessed after 10 and 20 wash and rinse cycles on terry fabrics according to grades (1=very soft, 5=very harsh).

The results of the soft hand test are shown in the Table below:

| No. | Number of wash cycles | A | B |
|---|---|---|---|
| 1 | 10 | 3.5 | 3 |
| | 20 | 3.5 | 3 |

Test Textile Washed/Treated with:
A: laundry detergent composition without silk (− silk)
B: laundry detergent composition with silk (+ silk)

Laundry detergent composition without silk (− silk): Ecolabel LLD with a dosage of 35.8 g. Laundry detergent composition with silk (+ silk): Ecolabel LLD with a dosage of 35.8 g+spider silk hydrogel (18.5 g) in 100 g water.

The experimental results show that the soft hand of the terry fabric washed/treated with a composition with silk (+ silk) was better than the soft hand of the terry fabric washed/treated with a composition without silk (− silk)

### 4) Scanning Electron Microscopy (SEM):

The test were carried out with the scanning electron microscope (SEM) JSM IT 500 from JEOL using a secondary electron detector. The JSM-IT500LA is a high-resolution scanning electron microscope with optional low vacuum operation and a tungsten hairpin cathode. The sample surface was vapour-plated with gold to ensure uniform conductivity of the samples. An accelerating voltage of 3.0-8.0 kV was applied.

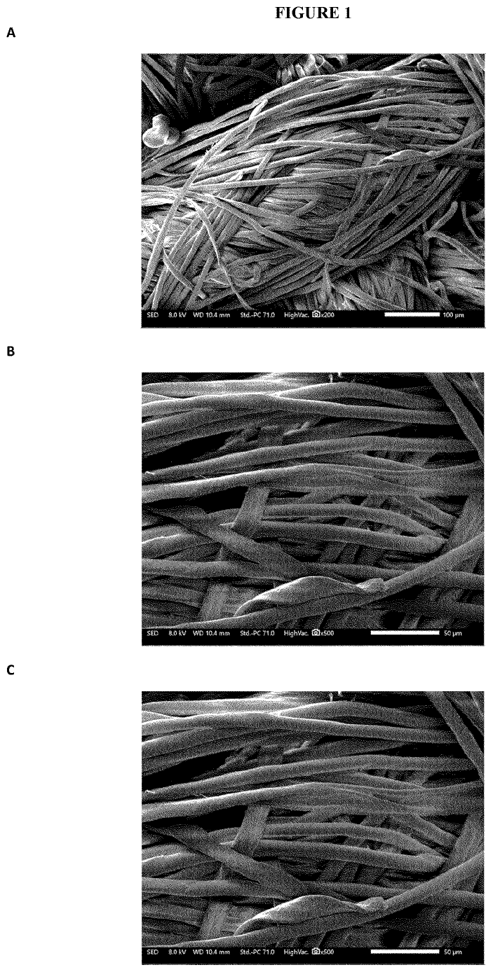

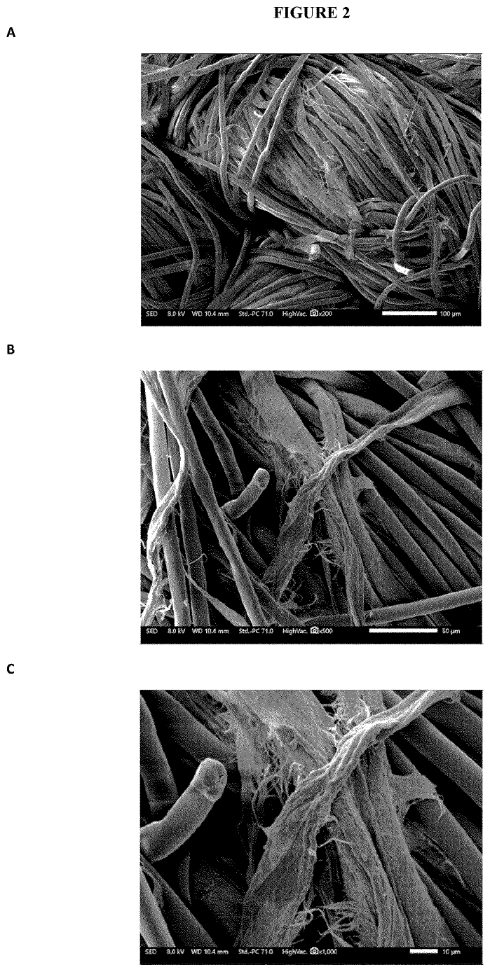

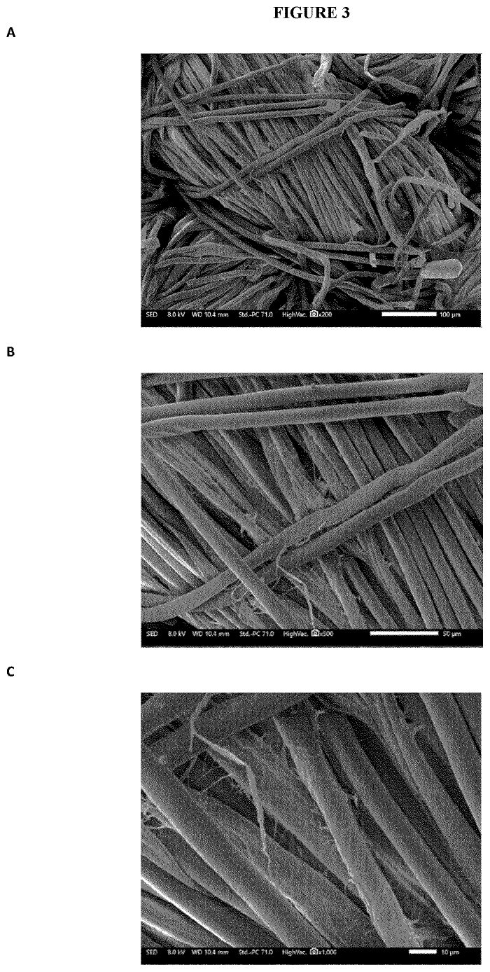

The results are shown in FIGS. 1 to 3. FIG. 1 shows a scanning electron microscope (SEM) image of surface structure of a new untreated textile (65% polyester (PES)/35% cotton (CO)) sample (A: 200× magnification; B: 500× magnification; C: 1000× magnification) Used abbreviations following DIN EN ISO 2076:2014-03 (chemical fibers) and DIN 60001-1:2001-05 (natural fibers). FIG. 2 shows a scanning electron microscope (SEM) image of surface structure of a textile (65% PES/35% CO) sample treated with Ecolabel LLD laundry detergent (A: 200× magnification; B: 500× magnification; C: 1000× magnification). The treatment with detergent alone (this FIGURE) shows a strong strain on the textile sample compared to untreated textile sample (see FIG. 1). FIG. 3 shows a scanning electron microscope (SEM) image of surface structure of a textile (65% PES/35% CO) sample treated with Ecolabel LLD laundry detergent and silk gel (A: 200× magnification; B: 500× magnification; C: 1000× magnification) The treatment with detergent alone (see FIG. 2) shows a very high strain on the textile sample compared to untreated textile sample (see FIG. 1). The comparison of the textile treated with detergent and silk gel (this FIGURE) shows a very low strain and therefore significantly higher material protection than that of a textile treated with detergent (see FIG. 2).

In the experiments described above, the use of the spider silk polypeptide C₁₆ is preferred.

1. A laundry detergent composition, comprising:
a) a structural polypeptide, and
b) at least one surfactant.

2. The laundry detergent composition according to claim 1, wherein the structural polypeptide a) is a silk polypeptide.

3. The laundry detergent composition according to claim 2, wherein the silk polypeptide
comprises or consists of a single unit of amino acids, or
comprises or consists of at least two identical repetitive units.

4. The laundry detergent composition according to claim 3, wherein the silk polypeptide is free of non-repetitive units.

5. The laundry detergent composition according to claim 3, wherein the single unit or the repetitive units are independently selected from the group consisting of
module C having an amino acid sequence according to SEQ ID NO: 1 or variants thereof,
module C^{Cys} having an amino acid sequence according to SEQ ID NO: 2 or variants thereof,
module C^{Lys} having an amino acid sequence according to SEQ ID NO: 3 or variants thereof.

6. The laundry detergent composition according to claim 5, wherein the silk polypeptide is selected from the group consisting of (C)ₘ, (C)ₘC^{Cys}, (C)ₘC^{Lys}, C^{Cys}(C)ₘ, C^{Lys}(C)ₘ, (C^{Cys})ₘ and (C^{Lys})ₘ, wherein m is an integer of 1 to 96.

7. The laundry detergent composition according to claim 6, wherein the silk polypeptide is selected from the group consisting of C₁, C₂, C₃, C₄, C₅, C₆, C₇, C₈, C₁₆, C₃₂, C₄₈, (C)₁C^{Cys}, (C)₂C^{Cys}, (C)₃C^{Cys}, (C)₄C^{Cys}, (C)₅C^{Cys}, (C)₆C^{Cys}, (C)₇C^{Cys}, (C)₈C^{Cys}, (C)₁₆C^{Cys}, (C)₃₂C^{Cys}, (C)₄₈C^{Cys}, (C)₁C^{Lys}, (C)₂C^{Lys}, (C)₃C^{Lys}, (C)₄C^{Lys}, (C)₅C^{Lys}, (C)₆C^{Lys}, (C)₇C^{Lys}, (C)₈C^{Lys}, (C)₁₆C^{Lys}, (C)₃₂C^{Lys}, (C)₄₈C^{Lys}, C^{Cys}(C)₁, C^{Cys}(C)₂, C^{Cys}(C)₃, C^{Cys}(C)₄, C^{Cys}(C)₅, C^{Cys}(C)₆, C^{Cys}(C)₇, C^{Cys}(C)₈, C^{Cys}(C)₁₆, C^{Cys}(C)₃₂, C^{Cys}(C)₄₈, C^{Lys}(C)₁, C^{Lys}(C)₂, C^{Lys}(C)₃, C^{Lys}(C)₄, C^{Lys}(C)₅, C^{Lys}(C)₆, C^{Lys}(C)₇, C^{Lys}(C)₈, C^{Lys}(C)₁₆, C^{Lys}(C)₃₂, C^{Lys}(C)₄₈, C^{Cys}₁, C^{Cys}₂, C^{Cys}₃, C^{Cys}₄, C^{Cys}₅, C^{Cys}₆, C^{Cys}₇, C^{Cys}₈, C^{Cys}₁₆, C^{Cys}₃₂, C^{Cys}₄₈, C^{Lys}₁, C^{Lys}₂, C^{Lys}₃, C^{Lys}₄, C^{Lys}₅, C^{Lys}₆, C^{Lys}₇, C^{Lys}₈, C^{Lys}₁₆, C^{Lys}₃₂ and C^{Lys}₄₈.

8. The laundry detergent composition according to claim 1, comprising from 0.0005 to 2.5% by weight, based on the total weight of the composition, of at least one structural polypeptide (component a)).

9. The laundry detergent composition according to claim 1, comprising
b1) at least one anionic surfactant, and
b2) optionally at least one nonionic surfactant.

10. The laundry detergent composition according to claim 9, comprising
from 3 to 60% by weight, based on the total weight of the composition, of at least one anionic surfactant b1), and
from 0 to 40% by weight, based on the total weight of the composition, of at least one nonionic surfactant b2).

11. The laundry detergent composition according to claim 1, comprising
a) at least one structural polypeptide,
b) at least one anionic surfactant b1), and optionally at least one nonionic surfactant b2),
c) optionally at least one builder,
d) optionally at least one enzyme,
e) optionally at least one polymeric antiredeposition agent,
f) optionally at least one bleach,
g) optionally at least one further additive different from components a) to f) selected from surfactants different from anionic and nonionic surfactants, rheology modifier, pH controlling agents, corrosion inhibitors, defoamers, dyes, fragrances, fillers, tableting aids, disintegrants, solubilizers, electrolytes, optical brighteners, hydrotropes, antimicrobial ingredients, antioxidants and mixtures thereof,
h) optionally at least one organic solvent,
i) optionally water.

12. The laundry detergent composition according to claim 1, wherein the laundry detergent composition is in liquid or gel form, or the laundry detergent composition is a unit dose article with a water-soluble packaging or coating.

13. A method for cleaning laundry in a washing machine, in which the laundry to be cleaned is contacted with a laundry detergent composition as defined in claim 1.

14. (canceled)

15. A method for
improving or maintaining the properties of textiles,
extending the life of textiles, or
reducing the amount of microfibres released from the textiles during washing, in which the textiles to be cleaned are contacted with an laundry detergent composition as defined in claim 1.

16. The method of claim 15, wherein the improving or maintaining encompasses one or more of improving or maintaining
i) the mechanical properties and/or usage properties of textiles,
ii) the optics of textiles,
iii) the haptic of textiles and/or
iv) the odour properties of textiles.

17. The laundry detergent composition according to claim 2, wherein the silk polypeptide is a spider silk polypeptide.

18. The laundry detergent composition according to claim 1, wherein the structural polypeptide is in the form of a gel.

19. The laundry detergent composition according to claim 18, wherein the gel is a hydrogel.
